(19) United States
(12) Patent Application Publication
(10) Pub. No.: US 2025/0129609 A1
(43) Pub. Date: Apr. 24, 2025

(54) MEMBRANES WITH IMPROVED SOLAR REFLECTANCE AND RELATED SYSTEMS AND METHODS

(71) Applicant: BMIC LLC, Dallas, TX (US)

(72) Inventor: Li-Ying Yang, Whippany, NJ (US)

(21) Appl. No.: 18/920,144

(22) Filed: Oct. 18, 2024

Related U.S. Application Data
(60) Provisional application No. 63/591,648, filed on Oct. 19, 2023.

(51) Int. Cl. E04D 5/10; E04D 5/14

(52) U.S. Cl. CPC E04D 5/10; E04D 5/148; B32B 2419/06

(57) ABSTRACT

Membranes are provided. A membrane comprises a cap layer, a core layer, and a substrate located between the cap layer and the core layer. The cap layer comprises a first cap sublayer and a second cap sublayer, with the second cap sublayer located between the first cap sublayer and the substrate. The first cap sublayer comprises a first thermoplastic polymer, and no greater than 10 parts of a first fire retardant per 100 parts of the first thermoplastic polymer. The second cap sublayer comprises a second thermoplastic polymer, and a second fire retardant, wherein an amount of the second fire retardant in the second cap sublayer is greater than an amount of the first fire retardant in the first cap sublayer. Related systems and methods are also provided.

### CROSS-REFERENCE TO RELATED APPLICATIONS

The present application claims priority to and benefit of U.S. Provisional Patent Application No. 63/591,648, filed Oct. 19, 2023 and entitled “MEMBRANES WITH IMPROVED SOLAR REFLECTANCE AND RELATED SYSTEMS AND METHODS,” the entirety of which is herein incorporated by reference.

### FIELD

This disclosure generally relates to membranes with improved solar reflectance, as well as related systems and related methods, among other things.

### BACKGROUND

Membranes installed on building structures are exposed to environmental conditions. The exposure of the membranes to environmental conditions reduces the performance of the membranes.

### SUMMARY

Some embodiments relate to a roofing membrane. In some embodiments, the roofing membrane comprises a cap layer. In some embodiments, the cap layer comprises a first cap sublayer. In some embodiments, the first cap sublayer comprises a first thermoplastic polymer. In some embodiments, the cap layer comprises a second cap sublayer. In some embodiments, the second cap sublayer comprises a second thermoplastic polymer. In some embodiments, the second cap sublayer comprises a second fire retardant. In some embodiments, the second cap layer comprises 20 parts to 90 parts of a second fire retardant per 100 parts of the second thermoplastic polymer. In some embodiments, the roofing membrane comprises a substrate. In some embodiments, the roofing membrane comprises a core layer. In some embodiments, the second cap sublayer is located between the first cap sublayer and the substrate. In some embodiments, the substrate is located between the second cap sublayer and the core layer.

In some embodiments, the first cap sublayer comprises 1 part to 10 parts of a first fire retardant per 100 parts of the first thermoplastic polymer.

In some embodiments, the first cap sublayer does not comprise a fire retardant.

In some embodiments, the first cap sublayer directly contacts the second cap sublayer.

In some embodiments, the second cap sublayer directly contacts the substrate.

In some embodiments, the substrate directly contacts the core layer.

In some embodiments, a thickness of the second cap sublayer is greater than a thickness of the first cap sublayer.

In some embodiments, the first cap layer has a thickness of 1 mil to 10 mils. In some embodiments, the second cap layer has a thickness of 10 mils to 100 mils.

In some embodiments, the first thermoplastic polymer is the same as the second thermoplastic polymer.

In some embodiments, the first thermoplastic polymer comprises a polypropylene copolymer.

In some embodiments, the second fire retardant is present in the second cap sublayer in an amount sufficient for the roofing membrane, when installed on a roofing substrate and tested for fire resistance, to pass the Class A UL790 fire resistance test.

In some embodiments, the roofing membrane, when tested according to ASTM D6878 and when inspected at 7× magnification according to the 3″ Mandrel Bend Test, does not exhibit cracks when subjected to Xenon Arc exposures of 25,000 KJ/m².

In some embodiments, the roofing membrane, when tested according to CRRC-1 Method #1, has a three-year aged solar reflectance that is greater than a control roofing membrane, wherein the control roofing membrane does not comprise the first cap sublayer.

In some embodiments, a three-year aged solar reflectance of the roofing membrane, when tested according to CRRC-1 Method #1, is within 10% of an initial solar reflectance of the roofing membrane.

In some embodiments, the roofing membrane, when tested according to ASTM D6878 at 275° F. and inspected at 7× magnification according to the 3″ Mandrel Bend Test, does not exhibit cracks for a duration 20 weeks.

Some embodiments relate to a roofing system. In some embodiments, the roofing system comprises a roofing substrate. In some embodiments, the roofing system comprises a roofing membrane. In some embodiments, the roofing membrane comprises a cap layer. In some embodiments, the cap layer comprises a first cap sublayer. In some embodiments, the first cap sublayer comprises a first thermoplastic polymer. In some embodiments, the first cap sublayer comprises 1 part to 10 parts of a first fire retardant per 100 parts of the first thermoplastic polymer. In some embodiments, the cap layer comprises a second cap sublayer. In some embodiments, the second cap sublayer comprises a second thermoplastic polymer. In some embodiments, the second cap sublayer comprises a second fire retardant. In some embodiments, the second cap layer comprises 20 parts to 90 parts of a second fire retardant per 100 parts of the second thermoplastic polymer. In some embodiments, the roofing membrane comprises a substrate. In some embodiments, the roofing membrane comprises a core layer. In some embodiments, the second cap sublayer is located between the first cap sublayer and the substrate. In some embodiments, the substrate is located between the second cap sublayer and the core layer. In some embodiments, the core layer is located between the substrate and the roofing substrate.

In some embodiments, the roofing substrate comprises at least one of a plywood substrate, a glass substrate, a cellulosic substrate, a roof shingle, a mat, a fabric, a glass mat, a fiberglass mat, an underlayment, a roofing membrane, a roof deck, a metal substrate, a protruding member, a photovoltaic (PV) panel, a modified bitumen (MODBIT) substrate, a roll good, a polyisocyanurate (ISO) foam board, a cover board, a pipe, a base sheet, a chimney, a wax paper, or any combination thereof.

In some embodiments, the first cap sublayer directly contacts the second cap sublayer.

In some embodiments, the second cap sublayer directly contacts the substrate.

In some embodiments, the substrate directly contacts the core layer.

In some embodiments, the core layer directly contacts the roofing substrate.

Some embodiments relate to a method of installation. In some embodiments, the method of installation comprises obtaining a roofing membrane. In some embodiments, the roofing membrane comprises a cap layer. In some embodiments, the cap layer comprises a first cap sublayer. In some embodiments, the first cap sublayer comprises a first thermoplastic polymer. In some embodiments, the first cap sublayer comprises 1 part to 10 parts of a first fire retardant per 100 parts of the first thermoplastic polymer. In some embodiments, the cap layer comprises a second cap sublayer. In some embodiments, the second cap sublayer comprises a second thermoplastic polymer. In some embodiments, the second cap sublayer comprises a second fire retardant. In some embodiments, the second cap layer comprises 20 parts to 90 parts of a second fire retardant per 100 parts of the second thermoplastic polymer. In some embodiments, the roofing membrane comprises a substrate. In some embodiments, the roofing membrane comprises a core layer. In some embodiments, the roofing membrane comprises an adhesive layer. In some embodiments, the roofing membrane comprises a release liner. In some embodiments, the second cap sublayer is located between the first cap sublayer and the substrate. In some embodiments, the substrate is located between the second cap sublayer and the core layer. In some embodiments, the core layer is located between the substrate and the adhesive layer. In some embodiments, the adhesive layer is located between the core layer and the release liner. In some embodiments, the release liner covers the adhesive layer. In some embodiments, the method of installation comprises removing the release liner from the adhesive layer, so as to expose the adhesive layer. In some embodiments, the method of installation comprises contacting the adhesive layer to a roofing substrate, so as to adhere the roofing membrane to the roofing substrate.

### BRIEF DESCRIPTION OF THE DRAWINGS

Reference is made to the drawings that form a part of this disclosure, and which illustrate embodiments in which the materials and methods described herein can be practiced.

FIG. 1 is a schematic diagram of a cross-section of a roofing membrane, according to some embodiments.

FIG. 2 is a schematic diagram of a cross-section of a roofing system, according to some embodiments.

FIG. 3 is a flowchart of a method for installing a membrane, according to some embodiments.

### DETAILED DESCRIPTION

Some embodiments relate to membranes for building structures. In some embodiments, a membrane comprises a cap layer, a core layer, and a substrate located between the cap layer and the core layer. In some embodiments, the cap layer comprises a first cap sublayer and a second cap sublayer, wherein the second cap sublayer is located between the first cap sublayer and the substrate. In some embodiments, the membrane exhibits an improved aging performance, when the second cap layer comprises a greater amount of a fire retardant than the first cap sublayer. In some embodiments, the membrane meets or exceeds performance requirements for fire retardancy, when the second cap layer comprises a greater amount of a fire retardant than the first cap sublayer. In some embodiments, the membrane exhibits other improvements with respect to membrane performance, when the second cap layer comprises a greater amount of a fire retardant than the first cap sublayer.

As used herein, the term “membrane” refers generally to a membrane for a building structure. In some embodiments, the membrane comprises a roofing membrane. In some embodiments, the membrane comprises a waterproofing membrane. In some embodiments, the membrane comprises a water vapor permeable membrane. In some embodiments, the membrane comprises an impermeable membrane. Although in some embodiments the term roofing membrane is used herein, it will be appreciated that the term roofing membrane may be used interchangeably with other types of membranes and thus is not limited to roofing membranes.

As used herein, the term “building structure” refers generally to a structure of a building. In some embodiments, for example, a building structure comprises a building frame structure, such that, when the membrane is installed on the building frame structure, the membrane forms all or a portion of a building envelope system and/or building wrap system. In some embodiments, a building structure comprises a roofing structure. For example, in some embodiments, a roofing structure comprises a roofing substrate. Non-limiting examples of roofing substrates include, for example and without limitation, at least one of a plywood substrate, a glass substrate, a cellulosic substrate, a roof shingle, a mat, a fabric, a glass mat, a fiberglass mat, an underlayment, a roofing membrane, a roof deck, a metal substrate, a protruding member, a photovoltaic (PV) panel, a modified bitumen (MODBIT) substrate, a roll good, a polyisocyanurate (ISO) foam board, a cover board, a pipe, a base sheet, a chimney, a wax paper, a cement, a concrete, or any combination thereof.

Some embodiments relate to a membrane. In some embodiments, the membrane comprises a cap layer. In some embodiments, the membrane comprises a substrate. In some embodiments, the membrane comprises a core layer. In some embodiments, the substrate is located between the cap layer and the core layer. In some embodiments, the substrate directly contacts the cap layer. In some embodiments, at least one intervening layer is located between the substrate and the cap layer. In some embodiments, the substrate directly contacts the core layer. In some embodiments, at least one intervening layer is located between the substrate and the core layer. It will be appreciated that any of the layers disclosed herein may include one or more sublayers, without departing from the scope of this disclosure.

In some embodiments, the membrane comprises the cap layer.

In some embodiments, the cap layer is an outermost layer of the membrane. For example, in some embodiments, at least a portion of the cap layer, when the membrane is installed, is exposed to an environment (e.g., subjected to conditions of an environment). In some embodiments, the cap layer comprises one or more sublayers. For example, in some embodiments, the cap layer comprises a first cap sublayer. In some embodiments, the cap layer comprises a second cap sublayer. In some embodiments, the second cap sublayer is located between the first cap sublayer and the substrate. In some embodiments, the second cap sublayer directly contacts the first cap sublayer. In some embodiments, the second cap sublayer is adhered to the first cap sublayer. In some embodiments, the second cap sublayer is bonded to the first cap sublayer. In some embodiments, the first cap sublayer and the second cap sublayer are coextruded sublayers. In some embodiments, the first cap sublayer and the second cap sublayer are laminated sublayers.

In some embodiments, an intervening layer is located between the first cap sublayer and the second cap sublayer. In some embodiments, the intervening layer comprises an adhesive layer. In some embodiments, the second cap sublayer directly contacts the substrate. In some embodiments, an intervening layer is located between the second cap sublayer and the substrate. In some embodiments, the intervening layer comprises an adhesive layer. In some embodiments, the cap layer is configured to directly contact a roofing substrate. In some embodiments, when the membrane is installed, the cap layer directly contacts a roofing substrate.

Although not shown, it will be appreciated that, in some embodiments, the cap layer may comprise additional cap sublayers. For example, in some embodiments, the cap layer comprises a third cap sublayer, a fourth cap sublayer, a fifth cap sublayer, a sixth cap sublayer, a seventh cap sublayer, an eighth cap sublayer, a ninth cap sublayer, a tenth cap sublayer, up to 100 or more cap sublayers. In some embodiments, each of the one or more cap sublayers directly contact each other. In some embodiments, an intervening layer is located between at least two cap sublayers. For example, in some embodiments, an adhesive layer is located between at least two cap sublayers.

In some embodiments, the first cap sublayer comprises a polymer. In some embodiments, the polymer comprises a thermoplastic polymer, such as, for example and without limitation, a thermoplastic polyolefin. In some embodiments, the polymer comprises at least one of a polyolefin, a polypropylene, a polyethylene, a polypropylene impact copolymer, an olefin block copolymer, a polypropylene elastomer, a polyethylene elastomer, or any combination thereof. In some embodiments, the polymer comprises at least one of ethylene-1-octene copolymer, propylene-ethylene copolymer, ethylene-1-butene copolymer, propylene-ethylene-1-butene copolymer, ethylene-1-hexene copolymer, ethylene-1-octene copolymer, ethylene-1-hexene-1-octene copolymer, propylene-ethylene-1-hexene copolymer, propylene-ethylene-1-octene copolymer, ethylene-1-butene-1-octene copolymer, or any combination thereof. In some embodiments, the olefin block copolymer comprises or is selected from the group consisting of at least one of propylene-ethylene copolymer, ethylene-1-octene copolymer, propylene-ethylene 1-butene copolymer, propylene-ethylene-1-hexene copolymer, propylene-ethylene-1-octene copolymer, ethylene-1-butene-1-octene copolymer, or any combination thereof.

Some non-limiting examples of the polymer (e.g., such as, one or more of thermoplastic polymers, polyolefins, thermoplastic polyolefins (TPO), vinyl polymers, polyvinyl esters, thermoplastic elastomers, recycled polymers, etc.) may include, without limitation, one or more of the following: polysiloxanes, silyl-terminated polymers (e.g., silyl-terminated polyethers and silyl-terminated polyurethanes, etc.), polyethylenes (PE) (e.g., including, without limitation, one or more of raw low density polyethylene, recycled low density polyethylene (LDPE), linear low density polyethylene (LLDPE), and high density polyethylene (HDPE)), polypropylene (PP) (e.g., including, without limitation, one or more of isotactic polypropylene (IPP), atactic polypropylene/isotactic propylene (APP/IPP)), polystyrene, polyurethane (PU/TPU), polyurea, terpolymers (e.g., including, without limitation, a functionalized polymer with a reactive oxygen group), amorphous polyalpha olefins (APAO), amorphous polyolefins (APO), (e.g., including, without limitation, one or more of propylene homopolymers, copolymers of propylene and ethylene, copolymers of ethylene alpha-olefin, such as ethylene and 1-octene, ethylene and 1-hexene, and ethylene and 1-butene), polyolefin elastomers (POE), styrene/styrenic block copolymers (e.g., including, without limitation, one or more of styrenic block copolymers with a hydrogenated midblock of styrene-ethylene/butylene-styrene (SEBS), styrene-ethylene/propylene-styrene (SEPS), styrene-isoprene-styrene block copolymers (SIS), and styrene-butadiene-styrene block copolymers (SBS)), ethylene vinyl acetate (EVA), polyisobutylene, polybutadiene, oxidized polyethylene, epoxy thermoplastics, raw polyvinyl butyral (PVB), polyvinyl chloride (PVC), recycled polyvinyl butyral (rPVB), polyvinyl acetate (PVAC), poly (vinyl butyrate), poly (vinyl propionate), poly (vinyl formate), and copolymers of PVAC (e.g., including, without limitation, copolymers of PVAC and EVA). Some non-limiting examples of the at least one polymer (e.g., including, without limitation, thermoplastic polymers, polyolefins, vinyl polymers, polyvinyl esters, and thermoplastic elastomers) may include, without limitation, one or more of the following: Vistamaxx® 6102 and Vistamaxx® 8880, which are polypropylenes (e.g., isotactic polypropylene (IPP)) and which are available from ExxonMobil, Irving, Tex.; Elvaloy®, which is a terpolymer and which is available from Dow/DuPont, Wilmington, Del.; Fusabond®, which is a chemically modified ethylene acrylate copolymer, a modified polyethylene, or any combination thereof and which is available from Dow/DuPont, Wilmington, Del.; RT2304, which is an amorphous polyalpha olefin (APAO) and which is available from Rextac APAO Polymers LLC, Odessa, Tex.; Eastoflex® P1023, which is an amorphous polyolefin (APO) comprising a propylene homopolymer and which is available from Eastman Chemical Company, Kingsport, Tenn.; Eastoflex® E1060, which is an amorphous polyolefin (APO) comprising a copolymer of propylene and ethylene and which is available from Eastman Chemical Company, Kingsport, Tenn.; Eastoflex® M1025, which is an amorphous polyolefin (APO) that comprises a blend of propylene homopolymer and copolymers of propylene and ethylene and which is available from Eastman Chemical Company, Kingsport, Tenn.; Engage® 7487, which is a polyolefin elastomer (POE) and which is available from Dow Inc., Midland, Mich.; SEBS 1657, which is a linear triblock copolymer based on styrene and ethylene/butylene, namely, styrene-ethylene/butylene-styrene (SEBS) and which is available Kraton™ Corporation, Houston, Tex.; D0243, D0246, D1101, D1102, D1116, D1118, D1152, D1155, D1157, D1184, D1189, D1191, and D1194, which are styrene butadiene styrene block copolymers comprising blocks of styrene and butadiene and which is available Kraton™ Corporation, Houston, Tex.; PI131350, which is a polyisobutylene and which is available from TPC Group, Houston, Tex.; ethylene bis stearamide (EBS), which is available from ACME-Hardesty Company, Blue Bell, Pa.; IPP, which is available from Bay Polymer Corp., Fremont, Calif.; and recycled low density polyethylene, which is available from Avangard Innovative, Houston, Tex. In some embodiments, the polymer comprises a polypropylene copolymer. In some embodiments, the polymer comprises ethylene propylene diene monomer.

In some embodiments, the first cap sublayer comprises a first fire retardant. In some embodiments, the first fire retardant comprises a substance that, when present, increases a fire resistance of the membrane relative to a membrane which does not comprise a fire retardant. In some embodiments, the first fire retardant comprises a halogenated fire retardant. In some embodiments, the first fire retardant comprises a non-halogenated fire retardant. In some embodiments, the first fire retardant comprises a halogenated fire retardant and a non-halogenated fire retardant. In some embodiments, the first fire retardant comprises at least one of magnesium hydroxide, magnesium dihydroxide, alumina trihydrate, zinc borate, ammonium polyphosphate, melamine polyphosphate, antimony oxide, hexabromocyclododecane, graphite, expandable graphite, N,N′-ethylene-bis(tetrabromophthalimide), or any combination thereof.

In some embodiments, the first cap sublayer comprises no greater than 10 parts of a first fire retardant per 100 parts of the first thermoplastic polymer. In some embodiments, the first cap sublayer comprises no greater than 9 parts of a first fire retardant per 100 parts of the first thermoplastic polymer. In some embodiments, the first cap sublayer comprises no greater than 8 parts of a first fire retardant per 100 parts of the first thermoplastic polymer. In some embodiments, the first cap sublayer comprises no greater than 7 parts of a first fire retardant per 100 parts of the first thermoplastic polymer. In some embodiments, the first cap sublayer comprises no greater than 6 parts of a first fire retardant per 100 parts of the first thermoplastic polymer. In some embodiments, the first cap sublayer comprises no greater than 5 parts of a first fire retardant per 100 parts of the first thermoplastic polymer. In some embodiments, the first cap sublayer comprises no greater than 4 parts of a first fire retardant per 100 parts of the first thermoplastic polymer. In some embodiments, the first cap sublayer comprises no greater than 3 parts of a first fire retardant per 100 parts of the first thermoplastic polymer. In some embodiments, the first cap sublayer comprises no greater than 2 parts of a first fire retardant per 100 parts of the first thermoplastic polymer. In some embodiments, the first cap sublayer comprises no greater than 1 parts of a first fire retardant per 100 parts of the first thermoplastic polymer. In some embodiments, the first cap sublayer does not comprise a first fire retardant. In some embodiments, the first cap sublayer does not comprise a fire retardant.

In some embodiments, the first cap sublayer comprises 1 part to 10 parts of a first fire retardant per 100 parts of the first thermoplastic polymer. In some embodiments, the first cap sublayer comprises 2 parts to 10 parts of a first fire retardant per 100 parts of the first thermoplastic polymer. In some embodiments, the first cap sublayer comprises 3 parts to 10 parts of a first fire retardant per 100 parts of the first thermoplastic polymer. In some embodiments, the first cap sublayer comprises 4 parts to 10 parts of a first fire retardant per 100 parts of the first thermoplastic polymer. In some embodiments, the first cap sublayer comprises 5 parts to 10 parts of a first fire retardant per 100 parts of the first thermoplastic polymer. In some embodiments, the first cap sublayer comprises 6 parts to 10 parts of a first fire retardant per 100 parts of the first thermoplastic polymer. In some embodiments, the first cap sublayer comprises 7 parts to 10 parts of a first fire retardant per 100 parts of the first thermoplastic polymer. In some embodiments, the first cap sublayer comprises 8 parts to 10 parts of a first fire retardant per 100 parts of the first thermoplastic polymer. In some embodiments, the first cap sublayer comprises 9 parts to 10 parts of a first fire retardant per 100 parts of the first thermoplastic polymer.

In some embodiments, the first cap sublayer comprises 1 part to 9 parts of a first fire retardant per 100 parts of the first thermoplastic polymer. In some embodiments, the first cap sublayer comprises 1 part to 8 parts of a first fire retardant per 100 parts of the first thermoplastic polymer. In some embodiments, the first cap sublayer comprises 1 part to 7 parts of a first fire retardant per 100 parts of the first thermoplastic polymer. In some embodiments, the first cap sublayer comprises 1 part to 6 parts of a first fire retardant per 100 parts of the first thermoplastic polymer. In some embodiments, the first cap sublayer comprises 1 part to 5 parts of a first fire retardant per 100 parts of the first thermoplastic polymer. In some embodiments, the first cap sublayer comprises 1 part to 4 parts of a first fire retardant per 100 parts of the first thermoplastic polymer. In some embodiments, the first cap sublayer comprises 1 part to 3 parts of a first fire retardant per 100 parts of the first thermoplastic polymer. In some embodiments, the first cap sublayer comprises 1 part to 2 parts of a first fire retardant per 100 parts of the first thermoplastic polymer.

In some embodiments, the first cap sublayer comprises a filler material. In some embodiments, the filler material comprises at least one of at least one of nepheline syenite, calcium carbonate, barium sulfate, iron oxide, diatomaceous earth, melamine, quartz, colloidal silica, crystalline silica, precipitated silica, amorphous silica, fumed silica, titanium dioxide, zinc oxide, zirconium oxide, zirconium silicate, zinc borate, chromic oxide, crystalline silica fine powder, amorphous silica fine powder, fumed silica powder, silicone rubber powder, glass powder, silica hydrogen, silica aero gel, calcium silicate, aluminum silicate, aluminum oxide, ferrite, carbon black, mica, clay, bentonite, ground quartz, kaolin, calcined kaolin, wollastonite, hydroxyapatite, hydrated alumina, magnesium hydroxide, vermiculite, talcum, slaked lime, calcium sulfate, talc, limestone, perlite, silica, colemanite, fly ash, recycled rubber tires, recycled shingles, recycled thermoplastic resins, basalt, or any combination thereof.

In some embodiments, the first cap sublayer comprises 10% to 90% by weight of the polymer based on a total weight of the first cap sublayer. In some embodiments, the first cap sublayer comprises 10% to 85% by weight of the polymer based on the total weight of the first cap sublayer. In some embodiments, the first cap sublayer comprises 10% to 80% by weight of the polymer based on the total weight of the first cap sublayer. In some embodiments, the first cap sublayer comprises 10% to 75% by weight of the polymer based on the total weight of the first cap sublayer. In some embodiments, the first cap sublayer comprises 10% to 70% by weight of the polymer based on the total weight of the first cap sublayer. In some embodiments, the first cap sublayer comprises 10% to 65% by weight of the polymer based on the total weight of the first cap sublayer. In some embodiments, the first cap sublayer comprises 10% to 60% by weight of the polymer based on the total weight of the first cap sublayer. In some embodiments, the first cap sublayer comprises 10% to 55% by weight of the polymer based on the total weight of the first cap sublayer. In some embodiments, the first cap sublayer comprises 10% to 50% by weight of the polymer based on the total weight of the first cap sublayer. In some embodiments, the first cap sublayer comprises 10% to 45% by weight of the polymer based on the total weight of the first cap sublayer. In some embodiments, the first cap sublayer comprises 10% to 40% by weight of the polymer based on the total weight of the first cap sublayer. In some embodiments, the first cap sublayer comprises 10% to 35% by weight of the polymer based on the total weight of the first cap sublayer. In some embodiments, the first cap sublayer comprises 10% to 30% by weight of the polymer based on the total weight of the first cap sublayer. In some embodiments, the first cap sublayer comprises 10% to 25% by weight of the polymer based on the total weight of the first cap sublayer. In some embodiments, the first cap sublayer comprises 10% to 20% by weight of the polymer based on the total weight of the first cap sublayer. In some embodiments, the first cap sublayer comprises 10% to 15% by weight of the polymer based on the total weight of the first cap sublayer.

In some embodiments, the first cap sublayer comprises 15% to 90% by weight of the polymer based on the total weight of the first cap sublayer. In some embodiments, the first cap sublayer comprises 20% to 90% by weight of the polymer based on the total weight of the first cap sublayer. In some embodiments, the first cap sublayer comprises 25% to 90% by weight of the polymer based on the total weight of the first cap sublayer. In some embodiments, the first cap sublayer comprises 30% to 90% by weight of the polymer based on the total weight of the first cap sublayer. In some embodiments, the first cap sublayer comprises 35% to 90% by weight of the polymer based on the total weight of the first cap sublayer. In some embodiments, the first cap sublayer comprises 40% to 90% by weight of the polymer based on the total weight of the first cap sublayer. In some embodiments, the first cap sublayer comprises 45% to 90% by weight of the polymer based on the total weight of the first cap sublayer. In some embodiments, the first cap sublayer comprises 50% to 90% by weight of the polymer based on the total weight of the first cap sublayer. In some embodiments, the first cap sublayer comprises 55% to 90% by weight of the polymer based on the total weight of the first cap sublayer. In some embodiments, the first cap sublayer comprises 60% to 90% by weight of the polymer based on the total weight of the first cap sublayer. In some embodiments, the first cap sublayer comprises 65% to 90% by weight of the polymer based on the total weight of the first cap sublayer. In some embodiments, the first cap sublayer comprises 70% to 90% by weight of the polymer based on the total weight of the first cap sublayer. In some embodiments, the first cap sublayer comprises 75% to 90% by weight of the polymer based on the total weight of the first cap sublayer. In some embodiments, the first cap sublayer comprises 80% to 90% by weight of the polymer based on the total weight of the first cap sublayer. In some embodiments, the first cap sublayer comprises 85% to 90% by weight of the polymer based on the total weight of the first cap sublayer.

In some embodiments, the first cap sublayer comprises 0.1% to 30% by weight of the first fire retardant based on the total weight of the first cap sublayer. In some embodiments, the first cap sublayer comprises 0.1% to 28% by weight of the first fire retardant based on the total weight of the first cap sublayer. In some embodiments, the first cap sublayer comprises 0.1% to 26% by weight of the first fire retardant based on the total weight of the first cap sublayer. In some embodiments, the first cap sublayer comprises 0.1% to 25% by weight of the first fire retardant based on the total weight of the first cap sublayer. In some embodiments, the first cap sublayer comprises 0.1% to 24% by weight of the first fire retardant based on the total weight of the first cap sublayer. In some embodiments, the first cap sublayer comprises 0.1% to 22% by weight of the first fire retardant based on the total weight of the first cap sublayer. In some embodiments, the first cap sublayer comprises 0.1% to 20% by weight of the first fire retardant based on the total weight of the first cap sublayer. In some embodiments, the first cap sublayer comprises 0.1% to 18% by weight of the first fire retardant based on the total weight of the first cap sublayer. In some embodiments, the first cap sublayer comprises 0.1% to 16% by weight of the first fire retardant based on the total weight of the first cap sublayer. In some embodiments, the first cap sublayer comprises 0.1% to 15% by weight of the first fire retardant based on the total weight of the first cap sublayer. In some embodiments, the first cap sublayer comprises 0.1% to 14% by weight of the first fire retardant based on the total weight of the first cap sublayer. In some embodiments, the first cap sublayer comprises 0.1% to 12% by weight of the first fire retardant based on the total weight of the first cap sublayer. In some embodiments, the first cap sublayer comprises 0.1% to 10% by weight of the first fire retardant based on the total weight of the first cap sublayer. In some embodiments, the first cap sublayer comprises 0.1% to 8% by weight of the first fire retardant based on the total weight of the first cap sublayer. In some embodiments, the first cap sublayer comprises 0.1% to 6% by weight of the first fire retardant based on the total weight of the first cap sublayer. In some embodiments, the first cap sublayer comprises 0.1% to 5% by weight of the first fire retardant based on the total weight of the first cap sublayer. In some embodiments, the first cap sublayer comprises 0.1% to 4% by weight of the first fire retardant based on the total weight of the first cap sublayer. In some embodiments, the first cap sublayer comprises 0.1% to 2% by weight of the first fire retardant based on the total weight of the first cap sublayer. In some embodiments, the first cap sublayer comprises 0.1% to 1% by weight of the first fire retardant based on the total weight of the first cap sublayer.

In some embodiments, the first cap sublayer comprises 1% to 30% by weight of the first fire retardant based on the total weight of the first cap sublayer. In some embodiments, the first cap sublayer comprises 2% to 30% by weight of the first fire retardant based on the total weight of the first cap sublayer. In some embodiments, the first cap sublayer comprises 4% to 30% by weight of the first fire retardant based on the total weight of the first cap sublayer. In some embodiments, the first cap sublayer comprises 5% to 30% by weight of the first fire retardant based on the total weight of the first cap sublayer. In some embodiments, the first cap sublayer comprises 6% to 30% by weight of the first fire retardant based on the total weight of the first cap sublayer. In some embodiments, the first cap sublayer comprises 8% to 30% by weight of the first fire retardant based on the total weight of the first cap sublayer. In some embodiments, the first cap sublayer comprises 10% to 30% by weight of the first fire retardant based on the total weight of the first cap sublayer. In some embodiments, the first cap sublayer comprises 12% to 30% by weight of the first fire retardant based on the total weight of the first cap sublayer. In some embodiments, the first cap sublayer comprises 14% to 30% by weight of the first fire retardant based on the total weight of the first cap sublayer. In some embodiments, the first cap sublayer comprises 15% to 30% by weight of the first fire retardant based on the total weight of the first cap sublayer. In some embodiments, the first cap sublayer comprises 16% to 30% by weight of the first fire retardant based on the total weight of the first cap sublayer. In some embodiments, the first cap sublayer comprises 18% to 30% by weight of the first fire retardant based on the total weight of the first cap sublayer. In some embodiments, the first cap sublayer comprises 20% to 30% by weight of the first fire retardant based on the total weight of the first cap sublayer. In some embodiments, the first cap sublayer comprises 22% to 30% by weight of the first fire retardant based on the total weight of the first cap sublayer. In some embodiments, the first cap sublayer comprises 24% to 30% by weight of the first fire retardant based on the total weight of the first cap sublayer. In some embodiments, the first cap sublayer comprises 25% to 30% by weight of the first fire retardant based on the total weight of the first cap sublayer. In some embodiments, the first cap sublayer comprises 26% to 30% by weight of the first fire retardant based on the total weight of the first cap sublayer. In some embodiments, the first cap sublayer comprises 28% to 30% by weight of the first fire retardant based on the total weight of the first cap sublayer.

As used herein, the term “substantially free” of a fire retardant refers to a composition comprises 5% by weight or less of the fire retardant based on a total weight of the composition. The term includes compositions comprising no fire retardant.

In some embodiments, the first cap sublayer is substantially free of the first fire retardant, when the first cap sublayer comprises 0.1% to 5% by weight of the first fire retardant based on the total weight of the first cap sublayer. In some embodiments, the first cap sublayer comprises 0.1% to 4.5% by weight of the first fire retardant based on the total weight of the first cap sublayer. In some embodiments, the first cap sublayer comprises 0.1% to 4% by weight of the first fire retardant based on the total weight of the first cap sublayer. In some embodiments, the first cap sublayer comprises 0.1% to 3.5% by weight of the first fire retardant based on the total weight of the first cap sublayer. In some embodiments, the first cap sublayer comprises 0.1% to 3% by weight of the first fire retardant based on the total weight of the first cap sublayer. In some embodiments, the first cap sublayer comprises 0.1% to 2.5% by weight of the first fire retardant based on the total weight of the first cap sublayer. In some embodiments, the first cap sublayer comprises 0.1% to 2% by weight of the first fire retardant based on the total weight of the first cap sublayer. In some embodiments, the first cap sublayer comprises 0.1% to 1% by weight of the first fire retardant based on the total weight of the first cap sublayer. In some embodiments, the first cap sublayer comprises 0.1% to 0.5% by weight of the first fire retardant based on the total weight of the first cap sublayer.

In some embodiments, the first cap sublayer comprises 0.5% to 5% by weight of the first fire retardant based on the total weight of the first cap sublayer. In some embodiments, the first cap sublayer comprises 1% to 5% by weight of the first fire retardant based on the total weight of the first cap sublayer. In some embodiments, the first cap sublayer comprises 1.5% to 5% by weight of the first fire retardant based on the total weight of the first cap sublayer. In some embodiments, the first cap sublayer comprises 2% to 5% by weight of the first fire retardant based on the total weight of the first cap sublayer. In some embodiments, the first cap sublayer comprises 2.5% to 5% by weight of the first fire retardant based on the total weight of the first cap sublayer. In some embodiments, the first cap sublayer comprises 3% to 5% by weight of the first fire retardant based on the total weight of the first cap sublayer. In some embodiments, the first cap sublayer comprises 3.5% to 5% by weight of the first fire retardant based on the total weight of the first cap sublayer. In some embodiments, the first cap sublayer comprises 4% to 5% by weight of the first fire retardant based on the total weight of the first cap sublayer. In some embodiments, the first cap sublayer comprises 4.5% to 5% by weight of the first fire retardant based on the total weight of the first cap sublayer.

As used herein, the term “free” of a fire retardant refers to a composition comprises 1% by weight or less of the fire retardant based on the total weight of the composition. The term includes compositions comprising no fire retardant.

In some embodiments, the first cap sublayer is free of the first fire retardant, when the first cap sublayer comprises 0.1% to 1% by weight of the first fire retardant based on the total weight of the first cap sublayer. In some embodiments, the first cap sublayer comprises 0.1% to 0.9% by weight of the first fire retardant based on the total weight of the first cap sublayer. In some embodiments, the first cap sublayer comprises 0.1% to 0.8% by weight of the first fire retardant based on the total weight of the first cap sublayer. In some embodiments, the first cap sublayer comprises 0.1% to 0.7% by weight of the first fire retardant based on the total weight of the first cap sublayer. In some embodiments, the first cap sublayer comprises 0.1% to 0.6% by weight of the first fire retardant based on the total weight of the first cap sublayer. In some embodiments, the first cap sublayer comprises 0.1% to 0.5% by weight of the first fire retardant based on the total weight of the first cap sublayer. In some embodiments, the first cap sublayer comprises 0.1% to 0.4% by weight of the first fire retardant based on the total weight of the first cap sublayer. In some embodiments, the first cap sublayer comprises 0.1% to 0.3% by weight of the first fire retardant based on the total weight of the first cap sublayer. In some embodiments, the first cap sublayer comprises 0.1% to 0.2% by weight of the first fire retardant based on the total weight of the first cap sublayer.

In some embodiments, the first cap sublayer comprises 0.2% to 1% by weight of the first fire retardant based on the total weight of the first cap sublayer. In some embodiments, the first cap sublayer comprises 0.3% to 1% by weight of the first fire retardant based on the total weight of the first cap sublayer. In some embodiments, the first cap sublayer comprises 0.4% to 1% by weight of the first fire retardant based on the total weight of the first cap sublayer. In some embodiments, the first cap sublayer comprises 0.5% to 1% by weight of the first fire retardant based on the total weight of the first cap sublayer. In some embodiments, the first cap sublayer comprises 0.6% to 1% by weight of the first fire retardant based on the total weight of the first cap sublayer. In some embodiments, the first cap sublayer comprises 0.7% to 1% by weight of the first fire retardant based on the total weight of the first cap sublayer. In some embodiments, the first cap sublayer comprises 0.8% to 1% by weight of the first fire retardant based on the total weight of the first cap sublayer. In some embodiments, the first cap sublayer comprises 0.9% to 1% by weight of the first fire retardant based on the total weight of the first cap sublayer.

In some embodiments, the first cap sublayer comprises 10% to 90% by weight of the filler based on the total weight of the first cap sublayer. In some embodiments, the first cap sublayer comprises 10% to 85% by weight of the filler based on the total weight of the first cap sublayer. In some embodiments, the first cap sublayer comprises 10% to 80% by weight of the filler based on the total weight of the first cap sublayer. In some embodiments, the first cap sublayer comprises 10% to 75% by weight of the filler based on the total weight of the first cap sublayer. In some embodiments, the first cap sublayer comprises 10% to 70% by weight of the filler based on the total weight of the first cap sublayer. In some embodiments, the first cap sublayer comprises 10% to 65% by weight of the filler based on the total weight of the first cap sublayer. In some embodiments, the first cap sublayer comprises 10% to 60% by weight of the filler based on the total weight of the first cap sublayer. In some embodiments, the first cap sublayer comprises 10% to 55% by weight of the filler based on the total weight of the first cap sublayer. In some embodiments, the first cap sublayer comprises 10% to 50% by weight of the filler based on the total weight of the first cap sublayer. In some embodiments, the first cap sublayer comprises 10% to 45% by weight of the filler based on the total weight of the first cap sublayer. In some embodiments, the first cap sublayer comprises 10% to 40% by weight of the filler based on the total weight of the first cap sublayer. In some embodiments, the first cap sublayer comprises 10% to 35% by weight of the filler based on the total weight of the first cap sublayer. In some embodiments, the first cap sublayer comprises 10% to 30% by weight of the filler based on the total weight of the first cap sublayer. In some embodiments, the first cap sublayer comprises 10% to 25% by weight of the filler based on the total weight of the first cap sublayer. In some embodiments, the first cap sublayer comprises 10% to 20% by weight of the filler based on the total weight of the first cap sublayer. In some embodiments, the first cap sublayer comprises 10% to 15% by weight of the filler based on the total weight of the first cap sublayer.

In some embodiments, the first cap sublayer comprises 15% to 90% by weight of the filler based on the total weight of the first cap sublayer. In some embodiments, the first cap sublayer comprises 20% to 90% by weight of the filler based on the total weight of the first cap sublayer. In some embodiments, the first cap sublayer comprises 25% to 90% by weight of the filler based on the total weight of the first cap sublayer. In some embodiments, the first cap sublayer comprises 30% to 90% by weight of the filler based on the total weight of the first cap sublayer. In some embodiments, the first cap sublayer comprises 35% to 90% by weight of the filler based on the total weight of the first cap sublayer. In some embodiments, the first cap sublayer comprises 40% to 90% by weight of the filler based on the total weight of the first cap sublayer. In some embodiments, the first cap sublayer comprises 45% to 90% by weight of the filler based on the total weight of the first cap sublayer. In some embodiments, the first cap sublayer comprises 50% to 90% by weight of the filler based on the total weight of the first cap sublayer. In some embodiments, the first cap sublayer comprises 55% to 90% by weight of the filler based on the total weight of the first cap sublayer. In some embodiments, the first cap sublayer comprises 60% to 90% by weight of the filler based on the total weight of the first cap sublayer. In some embodiments, the first cap sublayer comprises 65% to 90% by weight of the filler based on the total weight of the first cap sublayer. In some embodiments, the first cap sublayer comprises 70% to 90% by weight of the filler based on the total weight of the first cap sublayer. In some embodiments, the first cap sublayer comprises 75% to 90% by weight of the filler based on the total weight of the first cap sublayer. In some embodiments, the first cap sublayer comprises 80% to 90% by weight of the filler based on the total weight of the first cap sublayer. In some embodiments, the first cap sublayer comprises 85% to 90% by weight of the filler based on the total weight of the first cap sublayer.

In some embodiments, the first cap sublayer comprises at least one of a dispersing agent, an adhesion promoter, a colorant, a viscosity modifier, an ultraviolet (UV) absorber, a crosslinking agent, or any combination thereof.

In some embodiments, the dispersing agent comprises at least one of isopropyl alcohol, sodium dodecylbenzenesulfonate, sodium dodecylsulfonate, polyvinylpyrrolidone, sodium cholate, polystyrene, polyvinyl alcohol, or any combination thereof. In some embodiments, the dispersing agent is present in an amount of 0.1% to 10% by weight based on the total weight of the first cap sublayer, or any range or subrange therebetween.

In some embodiments, the adhesion promoter comprises at least one of tackifiers, styrene-butadiene-styrene copolymer (SBS) modifiers, atactic polypropylene (APP) modifiers, asphalt emulsions, ethylene vinyl acetate (EVA) copolymers, fatty acids, polyamines, tall oils, paraffin waxes, or any combination thereof. In some embodiments, the adhesion promoter is present in an amount of 0.01% to 5% by weight based on the total weight of the first cap sublayer, or any range or subrange therebetween.

In some embodiments, the colorant includes at least one of a mixed metal oxide pigment, a pearlescent pigment, a metal-coated flake, a metal oxide coated plate-like pigment, a mica, a metallic flake, an infrared-reflective pigment, a metallic powder, or any combination thereof. In some embodiments, the colorant is present in an amount of 0.5% to 50% by weight based on the total weight of the first cap sublayer, or any range or subrange therebetween.

In some embodiments, the viscosity modifier comprises at least one of hydroxyl ethyl cellulose (HEC), polyacrylamide (PAA), rheology modifiers, cellulosics, acrylics, associated thickeners, clays, organoclays, hydrogenated caster oils, polyamides, overbased sulphonates, or any combination thereof. In some embodiments, the viscosity modifier is present in an amount of 0.01% to 5% by weight based on the total weight of at least one of the first cap sublayer, or any range or subrange therebetween.

In some embodiments, the UV absorber comprises at least one of hindered amines, anti-oxidants, benzotriazoles, benzophenones, organic nickel compounds, cyanoacrylates, nanoparticles, zinc oxides, anatase, rutiles, or any combination thereof. In some embodiments, the UV absorber is present in an amount of 0.05% to 10% by weight based on the total weight of the first cap sublayer, or any range or subrange therebetween.

In some embodiments, the cross-linking agent comprises at least one of n-butyl polytitanate (BTP), phthalates, titanium chelates, titanium acetylacetonates, or any combination thereof. In some embodiments, the cross-linking agent is present in an amount of 0.01% to 5% by weight based on the total weight of the first cap sublayer, or any range or subrange therebetween.

In some embodiments, the first cap layer has a thickness of 1 mil to 100 mils. In some embodiments, the first cap layer has a thickness of 1 mil to 95 mils. In some embodiments, the first cap layer has a thickness of 1 mil to 90 mils. In some embodiments, the first cap layer has a thickness of 1 mil to 85 mils. In some embodiments, the first cap layer has a thickness of 1 mil to 80 mils. In some embodiments, the first cap layer has a thickness of 1 mil to 75 mils. In some embodiments, the first cap layer has a thickness of 1 mil to 70 mils. In some embodiments, the first cap layer has a thickness of 1 mil to 65 mils. In some embodiments, the first cap layer has a thickness of 1 mil to 60 mils. In some embodiments, the first cap layer has a thickness of 1 mil to 55 mils. In some embodiments, the first cap layer has a thickness of 1 mil to 50 mils. In some embodiments, the first cap layer has a thickness of 1 mil to 45 mils. In some embodiments, the first cap layer has a thickness of 1 mil to 40 mils. In some embodiments, the first cap layer has a thickness of 1 mil to 35 mils. In some embodiments, the first cap layer has a thickness of 1 mil to 30 mils. In some embodiments, the first cap layer has a thickness of 1 mil to 25 mils. In some embodiments, the first cap layer has a thickness of 1 mil to 20 mils. In some embodiments, the first cap layer has a thickness of 1 mil to 15 mils. In some embodiments, the first cap layer has a thickness of 1 mil to 10 mils. In some embodiments, the first cap layer has a thickness of 1 mil to 9 mils. In some embodiments, the first cap layer has a thickness of 1 mil to 8 mils. In some embodiments, the first cap layer has a thickness of 1 mil to 7 mils. In some embodiments, the first cap layer has a thickness of 1 mil to 6 mils. In some embodiments, the first cap layer has a thickness of 1 mil to 5 mils. In some embodiments, the first cap layer has a thickness of 1 mil to 4 mils. In some embodiments, the first cap layer has a thickness of 1 mil to 3 mils. In some embodiments, the first cap layer has a thickness of 1 mil to 2 mils.

In some embodiments, the first cap layer has a thickness of 5 mils to 100 mils. In some embodiments, the first cap layer has a thickness of 10 mils to 100 mils. In some embodiments, the first cap layer has a thickness of 15 mils to 100 mils. In some embodiments, the first cap layer has a thickness of 20 mils to 100 mils. In some embodiments, the first cap layer has a thickness of 25 mils to 100 mils. In some embodiments, the first cap layer has a thickness of 30 mils to 100 mils. In some embodiments, the first cap layer has a thickness of 35 mils to 100 mils. In some embodiments, the first cap layer has a thickness of 40 mils to 100 mils. In some embodiments, the first cap layer has a thickness of 45 mils to 100 mils. In some embodiments, the first cap layer has a thickness of 50 mils to 100 mils. In some embodiments, the first cap layer has a thickness of 55 mils to 100 mils. In some embodiments, the first cap layer has a thickness of 60 mils to 100 mils. In some embodiments, the first cap layer has a thickness of 65 mils to 100 mils. In some embodiments, the first cap layer has a thickness of 70 mils to 100 mils. In some embodiments, the first cap layer has a thickness of 75 mils to 100 mils. In some embodiments, the first cap layer has a thickness of 80 mils to 100 mils. In some embodiments, the first cap layer has a thickness of 85 mils to 100 mils. In some embodiments, the first cap layer has a thickness of 90 mils to 100 mils. In some embodiments, the first cap layer has a thickness of 95 mils to 100 mils.

In some embodiments, the second cap sublayer comprises a polymer. In some embodiments, the polymer comprises a thermoplastic polymer, such as, for example and without limitation, a thermoplastic polyolefin. In some embodiments, the polymer comprises at least one of a polyolefin, a polypropylene, a polyethylene, a polypropylene impact copolymer, an olefin block copolymer, a polypropylene elastomer, a polyethylene elastomer, or any combination thereof. In some embodiments, the polymer comprises at least one of ethylene-1-octene copolymer, propylene-ethylene copolymer, ethylene-1-butene copolymer, propylene-ethylene-1-butene copolymer, ethylene-1-hexene copolymer, ethylene-1-octene copolymer, ethylene-1-hexene-1-octene copolymer, propylene-ethylene-1-hexene copolymer, propylene-ethylene-1-octene copolymer, ethylene-1-butene-1-octene copolymer, or any combination thereof. In some embodiments, the olefin block copolymer comprises or is selected from the group consisting of at least one of propylene-ethylene copolymer, ethylene-1-octene copolymer, propylene-ethylene 1-butene copolymer, propylene-ethylene-1-hexene copolymer, propylene-ethylene-1-octene copolymer, ethylene-1-butene-1-octene copolymer, or any combination thereof.

Some non-limiting examples of the polymer (e.g., such as, one or more of thermoplastic polymers, polyolefins, thermoplastic polyolefins (TPO), vinyl polymers, polyvinyl esters, thermoplastic elastomers, recycled polymers, etc.) may include, without limitation, one or more of the following: polysiloxanes, silyl-terminated polymers (e.g., silyl-terminated polyethers and silyl-terminated polyurethanes, etc.), polyethylenes (PE) (e.g., including, without limitation, one or more of raw low density polyethylene, recycled low density polyethylene (LDPE), linear low density polyethylene (LLDPE), and high density polyethylene (HDPE)), polypropylene (PP) (e.g., including, without limitation, one or more of isotactic polypropylene (IPP), atactic polypropylene/isotactic propylene (APP/IPP)), polystyrene, polyurethane (PU/TPU), polyurea, terpolymers (e.g., including, without limitation, a functionalized polymer with a reactive oxygen group), amorphous polyalpha olefins (APAO), amorphous polyolefins (APO), (e.g., including, without limitation, one or more of propylene homopolymers, copolymers of propylene and ethylene, copolymers of ethylene alpha-olefin, such as ethylene and 1-octene, ethylene and 1-hexene, and ethylene and 1-butene), polyolefin elastomers (POE), styrene/styrenic block copolymers (e.g., including, without limitation, one or more of styrenic block copolymers with a hydrogenated midblock of styrene-ethylene/butylene-styrene (SEBS), styrene-ethylene/propylene-styrene (SEPS), styrene-isoprene-styrene block copolymers (SIS), and styrene-butadiene-styrene block copolymers (SBS)), ethylene vinyl acetate (EVA), polyisobutylene, polybutadiene, oxidized polyethylene, epoxy thermoplastics, raw polyvinyl butyral (PVB), polyvinyl chloride (PVC), recycled polyvinyl butyral (rPVB), polyvinyl acetate (PVAC), poly (vinyl butyrate), poly (vinyl propionate), poly (vinyl formate), and copolymers of PVAC (e.g., including, without limitation, copolymers of PVAC and EVA). Some non-limiting examples of the at least one polymer (e.g., including, without limitation, thermoplastic polymers, polyolefins, vinyl polymers, polyvinyl esters, and thermoplastic elastomers) may include, without limitation, one or more of the following: Vistamaxx® 6102 and Vistamaxx® 8880, which are polypropylenes (e.g., isotactic polypropylene (IPP)) and which are available from ExxonMobil, Irving, Tex.; Elvaloy®, which is a terpolymer and which is available from Dow/DuPont, Wilmington, Del.; Fusabond®, which is a chemically modified ethylene acrylate copolymer, a modified polyethylene, or any combination thereof and which is available from Dow/DuPont, Wilmington, Del.; RT2304, which is an amorphous polyalpha olefin (APAO) and which is available from Rextac APAO Polymers LLC, Odessa, Tex.; Eastoflex® P1023, which is an amorphous polyolefin (APO) comprising a propylene homopolymer and which is available from Eastman Chemical Company, Kingsport, Tenn.; Eastoflex® E1060, which is an amorphous polyolefin (APO) comprising a copolymer of propylene and ethylene and which is available from Eastman Chemical Company, Kingsport, Tenn.; Eastoflex® M1025, which is an amorphous polyolefin (APO) that comprises a blend of propylene homopolymer and copolymers of propylene and ethylene and which is available from Eastman Chemical Company, Kingsport, Tenn.; Engage® 7487, which is a polyolefin elastomer (POE) and which is available from Dow Inc., Midland, Mich.; SEBS 1657, which is a linear triblock copolymer based on styrene and ethylene/butylene, namely, styrene-ethylene/butylene-styrene (SEBS) and which is available Kraton™ Corporation, Houston, Tex.; D0243, D0246, D1101, D1102, D1116, D1118, D1152, D1155, D1157, D1184, D1189, D1191, and D1194, which are styrene butadiene styrene block copolymers comprising blocks of styrene and butadiene and which is available Kraton™ Corporation, Houston, Tex.; PI131350, which is a polyisobutylene and which is available from TPC Group, Houston, Tex.; ethylene bis stearamide (EBS), which is available from ACME-Hardesty Company, Blue Bell, Pa.; IPP, which is available from Bay Polymer Corp., Fremont, Calif.; and recycled low density polyethylene, which is available from Avangard Innovative, Houston, Tex. In some embodiments, the polymer comprises a polypropylene copolymer. In some embodiments, the polymer comprises ethylene propylene diene monomer.

In some embodiments, at least one of the polymers of the second cap sublayer is the same as at least one of the polymers of the first cap sublayer. In some embodiments, at least one of the polymers of the second cap sublayer is different from at least one of the polymers of the first cap sublayer. In some embodiments, the second thermoplastic polymer is the same as the first thermoplastic polymer.

In some embodiments, the second cap sublayer comprises a second fire retardant. In some embodiments, the second fire retardant comprises a substance that, when present, increases a fire resistance of the membrane relative to a membrane which does not comprise a fire retardant. In some embodiments, the second fire retardant comprises a halogenated fire retardant. In some embodiments, the second fire retardant comprises a non-halogenated fire retardant. In some embodiments, the second fire retardant comprises a halogenated fire retardant and a non-halogenated fire retardant. In some embodiments, the second fire retardant comprises at least one of magnesium hydroxide, magnesium dihydroxide, alumina trihydrate, zinc borate, ammonium polyphosphate, melamine polyphosphate, antimony oxide, hexabromocyclododecane, graphite, expandable graphite, N,N′-ethylene-bis(tetrabromophthalimide), or any combination thereof.

In some embodiments, an amount of the second fire retardant in the second cap sublayer is greater than an amount of the first fire retardant in the first cap sublayer. In some embodiments, the amount of the second fire retardant in the second cap layer is at least 0.1 times greater than the amount of the first fire retardant in the first cap sublayer. In some embodiments, the amount of the second fire retardant in the second cap layer is at least 0.5 times greater than the amount of the first fire retardant in the first cap sublayer. In some embodiments, the amount of the second fire retardant in the second cap layer is at least 1 times greater than the amount of the first fire retardant in the first cap sublayer. In some embodiments, the amount of the second fire retardant in the second cap layer is at least 2 times greater than the amount of the first fire retardant in the first cap sublayer. In some embodiments, the amount of the second fire retardant in the second cap layer is at least 3 times greater than the amount of the first fire retardant in the first cap sublayer. In some embodiments, the amount of the second fire retardant in the second cap layer is at least 4 times greater than the amount of the first fire retardant in the first cap sublayer. In some embodiments, the amount of the second fire retardant in the second cap layer is at least 5 times greater than the amount of the first fire retardant in the first cap sublayer. In some embodiments, the amount of the second fire retardant in the second cap layer is at least 6 times greater than the amount of the first fire retardant in the first cap sublayer. In some embodiments, the amount of the second fire retardant in the second cap layer is at least 7 times greater than the amount of the first fire retardant in the first cap sublayer. In some embodiments, the amount of the second fire retardant in the second cap layer is at least 8 times greater than the amount of the first fire retardant in the first cap sublayer. In some embodiments, the amount of the second fire retardant in the second cap layer is at least 9 times greater than the amount of the first fire retardant in the first cap sublayer. In some embodiments, the amount of the second fire retardant in the second cap layer is at least 10 times greater than the amount of the first fire retardant in the first cap sublayer. In some embodiments, the amount of the second fire retardant in the second cap layer is at least 11 times greater than the amount of the first fire retardant in the first cap sublayer. In some embodiments, the amount of the second fire retardant in the second cap layer is at least 12 times greater than the amount of the first fire retardant in the first cap sublayer. In some embodiments, the amount of the second fire retardant in the second cap layer is at least 13 times greater than the amount of the first fire retardant in the first cap sublayer. In some embodiments, the amount of the second fire retardant in the second cap layer is at least 14 times greater than the amount of the first fire retardant in the first cap sublayer. In some embodiments, the amount of the second fire retardant in the second cap layer is at least 15 times greater than the amount of the first fire retardant in the first cap sublayer.

In some embodiments, the amount of the second fire retardant in the second cap layer is 1 time to 20 times greater than the amount of the first fire retardant in the first cap sublayer. In some embodiments, the amount of the second fire retardant in the second cap layer is 1 time to 19 times greater than the amount of the first fire retardant in the first cap sublayer. In some embodiments, the amount of the second fire retardant in the second cap layer is 1 time to 18 times greater than the amount of the first fire retardant in the first cap sublayer. In some embodiments, the amount of the second fire retardant in the second cap layer is 1 time to 17 times greater than the amount of the first fire retardant in the first cap sublayer. In some embodiments, the amount of the second fire retardant in the second cap layer is 1 time to 16 times greater than the amount of the first fire retardant in the first cap sublayer. In some embodiments, the amount of the second fire retardant in the second cap layer is 1 time to 15 times greater than the amount of the first fire retardant in the first cap sublayer. In some embodiments, the amount of the second fire retardant in the second cap layer is 1 time to 14 times greater than the amount of the first fire retardant in the first cap sublayer. In some embodiments, the amount of the second fire retardant in the second cap layer is 1 time to 13 times greater than the amount of the first fire retardant in the first cap sublayer. In some embodiments, the amount of the second fire retardant in the second cap layer is 1 time to 12 times greater than the amount of the first fire retardant in the first cap sublayer. In some embodiments, the amount of the second fire retardant in the second cap layer is 1 time to 11 times greater than the amount of the first fire retardant in the first cap sublayer. In some embodiments, the amount of the second fire retardant in the second cap layer is 1 time to 10 times greater than the amount of the first fire retardant in the first cap sublayer. In some embodiments, the amount of the second fire retardant in the second cap layer is 1 time to 9 times greater than the amount of the first fire retardant in the first cap sublayer. In some embodiments, the amount of the second fire retardant in the second cap layer is 1 time to 8 times greater than the amount of the first fire retardant in the first cap sublayer. In some embodiments, the amount of the second fire retardant in the second cap layer is 1 time to 7 times greater than the amount of the first fire retardant in the first cap sublayer. In some embodiments, the amount of the second fire retardant in the second cap layer is 1 time to 6 times greater than the amount of the first fire retardant in the first cap sublayer. In some embodiments, the amount of the second fire retardant in the second cap layer is 1 time to 5 times greater than the amount of the first fire retardant in the first cap sublayer. In some embodiments, the amount of the second fire retardant in the second cap layer is 1 time to 4 times greater than the amount of the first fire retardant in the first cap sublayer. In some embodiments, the amount of the second fire retardant in the second cap layer is 1 time to 3 times greater than the amount of the first fire retardant in the first cap sublayer. In some embodiments, the amount of the second fire retardant in the second cap layer is 1 time to 2 times greater than the amount of the first fire retardant in the first cap sublayer.

In some embodiments, the amount of the second fire retardant in the second cap layer is 0.1 times to 20 times greater than the amount of the first fire retardant in the first cap sublayer. In some embodiments, the amount of the second fire retardant in the second cap layer is 0.5 times to 20 times greater than the amount of the first fire retardant in the first cap sublayer. In some embodiments, the amount of the second fire retardant in the second cap layer is 1 times to 20 times greater than the amount of the first fire retardant in the first cap sublayer. In some embodiments, the amount of the second fire retardant in the second cap layer is 2 times to 20 times greater than the amount of the first fire retardant in the first cap sublayer. In some embodiments, the amount of the second fire retardant in the second cap layer is 3 times to 20 times greater than the amount of the first fire retardant in the first cap sublayer. In some embodiments, the amount of the second fire retardant in the second cap layer is 4 times to 20 times greater than the amount of the first fire retardant in the first cap sublayer. In some embodiments, the amount of the second fire retardant in the second cap layer is 5 times to 20 times greater than the amount of the first fire retardant in the first cap sublayer. In some embodiments, the amount of the second fire retardant in the second cap layer is 6 times to 20 times greater than the amount of the first fire retardant in the first cap sublayer. In some embodiments, the amount of the second fire retardant in the second cap layer is 7 times to 20 times greater than the amount of the first fire retardant in the first cap sublayer. In some embodiments, the amount of the second fire retardant in the second cap layer is 8 times to 20 times greater than the amount of the first fire retardant in the first cap sublayer. In some embodiments, the amount of the second fire retardant in the second cap layer is 9 times to 20 times greater than the amount of the first fire retardant in the first cap sublayer. In some embodiments, the amount of the second fire retardant in the second cap layer is 10 times to 20 times greater than the amount of the first fire retardant in the first cap sublayer. In some embodiments, the amount of the second fire retardant in the second cap layer is 11 times to 20 times greater than the amount of the first fire retardant in the first cap sublayer. In some embodiments, the amount of the second fire retardant in the second cap layer is 12 times to 20 times greater than the amount of the first fire retardant in the first cap sublayer. In some embodiments, the amount of the second fire retardant in the second cap layer is 13 times to 20 times greater than the amount of the first fire retardant in the first cap sublayer. In some embodiments, the amount of the second fire retardant in the second cap layer is 14 times to 20 times greater than the amount of the first fire retardant in the first cap sublayer. In some embodiments, the amount of the second fire retardant in the second cap layer is 15 times to 20 times greater than the amount of the first fire retardant in the first cap sublayer. In some embodiments, the amount of the second fire retardant in the second cap layer is 16 times to 20 times greater than the amount of the first fire retardant in the first cap sublayer. In some embodiments, the amount of the second fire retardant in the second cap layer is 17 times to 20 times greater than the amount of the first fire retardant in the first cap sublayer. In some embodiments, the amount of the second fire retardant in the second cap layer is 18 times to 20 times greater than the amount of the first fire retardant in the first cap sublayer. In some embodiments, the amount of the second fire retardant in the second cap layer is 19 times to 20 times greater than the amount of the first fire retardant in the first cap sublayer.

In some embodiments, the second cap sublayer comprises 20 parts to 90 parts of the second fire retardant per 100 parts of the second thermoplastic polymer. In some embodiments, the second cap sublayer comprises 20 parts to 85 parts of the second fire retardant per 100 parts of the second thermoplastic polymer. In some embodiments, the second cap sublayer comprises 20 parts to 80 parts of the second fire retardant per 100 parts of the second thermoplastic polymer. In some embodiments, the second cap sublayer comprises 20 parts to 75 parts of the second fire retardant per 100 parts of the second thermoplastic polymer. In some embodiments, the second cap sublayer comprises 20 parts to 70 parts of the second fire retardant per 100 parts of the second thermoplastic polymer. In some embodiments, the second cap sublayer comprises 20 parts to 65 parts of the second fire retardant per 100 parts of the second thermoplastic polymer. In some embodiments, the second cap sublayer comprises 20 parts to 60 parts of the second fire retardant per 100 parts of the second thermoplastic polymer. In some embodiments, the second cap sublayer comprises 20 parts to 55 parts of the second fire retardant per 100 parts of the second thermoplastic polymer. In some embodiments, the second cap sublayer comprises 20 parts to 50 parts of the second fire retardant per 100 parts of the second thermoplastic polymer. In some embodiments, the second cap sublayer comprises 20 parts to 45 parts of the second fire retardant per 100 parts of the second thermoplastic polymer. In some embodiments, the second cap sublayer comprises 20 parts to 40 parts of the second fire retardant per 100 parts of the second thermoplastic polymer. In some embodiments, the second cap sublayer comprises 20 parts to 35 parts of the second fire retardant per 100 parts of the second thermoplastic polymer. In some embodiments, the second cap sublayer comprises 20 parts to 30 parts of the second fire retardant per 100 parts of the second thermoplastic polymer. In some embodiments, the second cap sublayer comprises 20 parts to 25 parts of the second fire retardant per 100 parts of the second thermoplastic polymer.

In some embodiments, the second cap sublayer comprises 25 parts to 90 parts of the second fire retardant per 100 parts of the second thermoplastic polymer. In some embodiments, the second cap sublayer comprises 30 parts to 90 parts of the second fire retardant per 100 parts of the second thermoplastic polymer. In some embodiments, the second cap sublayer comprises 35 parts to 90 parts of the second fire retardant per 100 parts of the second thermoplastic polymer. In some embodiments, the second cap sublayer comprises 40 parts to 90 parts of the second fire retardant per 100 parts of the second thermoplastic polymer. In some embodiments, the second cap sublayer comprises 45 parts to 90 parts of the second fire retardant per 100 parts of the second thermoplastic polymer. In some embodiments, the second cap sublayer comprises 50 parts to 90 parts of the second fire retardant per 100 parts of the second thermoplastic polymer. In some embodiments, the second cap sublayer comprises 55 parts to 90 parts of the second fire retardant per 100 parts of the second thermoplastic polymer. In some embodiments, the second cap sublayer comprises 60 parts to 90 parts of the second fire retardant per 100 parts of the second thermoplastic polymer. In some embodiments, the second cap sublayer comprises 65 parts to 90 parts of the second fire retardant per 100 parts of the second thermoplastic polymer. In some embodiments, the second cap sublayer comprises 70 parts to 90 parts of the second fire retardant per 100 parts of the second thermoplastic polymer. In some embodiments, the second cap sublayer comprises 75 parts to 90 parts of the second fire retardant per 100 parts of the second thermoplastic polymer. In some embodiments, the second cap sublayer comprises 80 parts to 90 parts of the second fire retardant per 100 parts of the second thermoplastic polymer. In some embodiments, the second cap sublayer comprises 85 parts to 90 parts of the second fire retardant per 100 parts of the second thermoplastic polymer.

In some embodiments, the second cap sublayer comprises a filler material. In some embodiments, the filler material comprises at least one of at least one of nepheline syenite, calcium carbonate, barium sulfate, iron oxide, diatomaceous earth, melamine, quartz, colloidal silica, crystalline silica, precipitated silica, amorphous silica, fumed silica, titanium dioxide, zinc oxide, zirconium oxide, zirconium silicate, zinc borate, chromic oxide, crystalline silica fine powder, amorphous silica fine powder, fumed silica powder, silicone rubber powder, glass powder, silica hydrogen, silica aero gel, calcium silicate, aluminum silicate, aluminum oxide, ferrite, carbon black, mica, clay, bentonite, ground quartz, kaolin, calcined kaolin, wollastonite, hydroxyapatite, hydrated alumina, magnesium hydroxide, vermiculite, talcum, slaked lime, calcium sulfate, talc, limestone, perlite, silica, colemanite, fly ash, recycled rubber tires, recycled shingles, recycled thermoplastic resins, basalt, or any combination thereof.

In some embodiments, the second cap sublayer comprises 10% to 90% by weight of the polymer based on a total weight of the second cap sublayer. In some embodiments, the second cap sublayer comprises 10% to 85% by weight of the polymer based on the total weight of the second cap sublayer. In some embodiments, the second cap sublayer comprises 10% to 80% by weight of the polymer based on the total weight of the second cap sublayer. In some embodiments, the second cap sublayer comprises 10% to 75% by weight of the polymer based on the total weight of the second cap sublayer. In some embodiments, the second cap sublayer comprises 10% to 70% by weight of the polymer based on the total weight of the second cap sublayer. In some embodiments, the second cap sublayer comprises 10% to 65% by weight of the polymer based on the total weight of the second cap sublayer. In some embodiments, the second cap sublayer comprises 10% to 60% by weight of the polymer based on the total weight of the second cap sublayer. In some embodiments, the second cap sublayer comprises 10% to 55% by weight of the polymer based on the total weight of the second cap sublayer. In some embodiments, the second cap sublayer comprises 10% to 50% by weight of the polymer based on the total weight of the second cap sublayer. In some embodiments, the second cap sublayer comprises 10% to 45% by weight of the polymer based on the total weight of the second cap sublayer. In some embodiments, the second cap sublayer comprises 10% to 40% by weight of the polymer based on the total weight of the second cap sublayer. In some embodiments, the second cap sublayer comprises 10% to 35% by weight of the polymer based on the total weight of the second cap sublayer. In some embodiments, the second cap sublayer comprises 10% to 30% by weight of the polymer based on the total weight of the second cap sublayer. In some embodiments, the second cap sublayer comprises 10% to 25% by weight of the polymer based on the total weight of the second cap sublayer. In some embodiments, the second cap sublayer comprises 10% to 20% by weight of the polymer based on the total weight of the second cap sublayer. In some embodiments, the second cap sublayer comprises 10% to 15% by weight of the polymer based on the total weight of the second cap sublayer.

In some embodiments, the second cap sublayer comprises 15% to 90% by weight of the polymer based on the total weight of the second cap sublayer. In some embodiments, the second cap sublayer comprises 20% to 90% by weight of the polymer based on the total weight of the second cap sublayer. In some embodiments, the second cap sublayer comprises 25% to 90% by weight of the polymer based on the total weight of the second cap sublayer. In some embodiments, the second cap sublayer comprises 30% to 90% by weight of the polymer based on the total weight of the second cap sublayer. In some embodiments, the second cap sublayer comprises 35% to 90% by weight of the polymer based on the total weight of the second cap sublayer. In some embodiments, the second cap sublayer comprises 40% to 90% by weight of the polymer based on the total weight of the second cap sublayer. In some embodiments, the second cap sublayer comprises 45% to 90% by weight of the polymer based on the total weight of the second cap sublayer. In some embodiments, the second cap sublayer comprises 50% to 90% by weight of the polymer based on the total weight of the second cap sublayer. In some embodiments, the second cap sublayer comprises 55% to 90% by weight of the polymer based on the total weight of the second cap sublayer. In some embodiments, the second cap sublayer comprises 60% to 90% by weight of the polymer based on the total weight of the second cap sublayer. In some embodiments, the second cap sublayer comprises 65% to 90% by weight of the polymer based on the total weight of the second cap sublayer. In some embodiments, the second cap sublayer comprises 70% to 90% by weight of the polymer based on the total weight of the second cap sublayer. In some embodiments, the second cap sublayer comprises 75% to 90% by weight of the polymer based on the total weight of the second cap sublayer. In some embodiments, the second cap sublayer comprises 80% to 90% by weight of the polymer based on the total weight of the second cap sublayer. In some embodiments, the second cap sublayer comprises 85% to 90% by weight of the polymer based on the total weight of the second cap sublayer.

In some embodiments, the second fire retardant is present in the second cap sublayer in an amount sufficient for the roofing membrane, when installed on a roofing substrate and tested for fire resistance, to pass the Class A UL790 fire resistance test.

In some embodiments, the second cap sublayer comprises 10% to 80% by weight of the second fire retardant based on the total weight of the second cap sublayer. In some embodiments, the second cap sublayer comprises 10% to 75% by weight of the second fire retardant based on the total weight of the second cap sublayer. In some embodiments, the second cap sublayer comprises 10% to 70% by weight of the second fire retardant based on the total weight of the second cap sublayer. In some embodiments, the second cap sublayer comprises 10% to 65% by weight of the second fire retardant based on the total weight of the second cap sublayer. In some embodiments, the second cap sublayer comprises 10% to 60% by weight of the second fire retardant based on the total weight of the second cap sublayer. In some embodiments, the second cap sublayer comprises 10% to 55% by weight of the second fire retardant based on the total weight of the second cap sublayer. In some embodiments, the second cap sublayer comprises 10% to 50% by weight of the second fire retardant based on the total weight of the second cap sublayer. In some embodiments, the second cap sublayer comprises 10% to 45% by weight of the second fire retardant based on the total weight of the second cap sublayer. In some embodiments, the second cap sublayer comprises 10% to 40% by weight of the second fire retardant based on the total weight of the second cap sublayer. In some embodiments, the second cap sublayer comprises 10% to 35% by weight of the second fire retardant based on the total weight of the second cap sublayer. In some embodiments, the second cap sublayer comprises 10% to 30% by weight of the second fire retardant based on the total weight of the second cap sublayer. In some embodiments, the second cap sublayer comprises 10% to 25% by weight of the second fire retardant based on the total weight of the second cap sublayer. In some embodiments, the second cap sublayer comprises 10% to 20% by weight of the second fire retardant based on the total weight of the second cap sublayer. In some embodiments, the second cap sublayer comprises 10% to 15% by weight of the second fire retardant based on the total weight of the second cap sublayer.

In some embodiments, the second cap sublayer comprises 15% to 80% by weight of the second fire retardant based on the total weight of the second cap sublayer. In some embodiments, the second cap sublayer comprises 20% to 80% by weight of the second fire retardant based on the total weight of the second cap sublayer. In some embodiments, the second cap sublayer comprises 25% to 80% by weight of the second fire retardant based on the total weight of the second cap sublayer. In some embodiments, the second cap sublayer comprises 30% to 80% by weight of the second fire retardant based on the total weight of the second cap sublayer. In some embodiments, the second cap sublayer comprises 35% to 80% by weight of the second fire retardant based on the total weight of the second cap sublayer. In some embodiments, the second cap sublayer comprises 40% to 80% by weight of the second fire retardant based on the total weight of the second cap sublayer. In some embodiments, the second cap sublayer comprises 45% to 80% by weight of the second fire retardant based on the total weight of the second cap sublayer. In some embodiments, the second cap sublayer comprises 50% to 80% by weight of the second fire retardant based on the total weight of the second cap sublayer. In some embodiments, the second cap sublayer comprises 55% to 80% by weight of the second fire retardant based on the total weight of the second cap sublayer. In some embodiments, the second cap sublayer comprises 60% to 80% by weight of the second fire retardant based on the total weight of the second cap sublayer. In some embodiments, the second cap sublayer comprises 65% to 80% by weight of the second fire retardant based on the total weight of the second cap sublayer. In some embodiments, the second cap sublayer comprises 70% to 80% by weight of the second fire retardant based on the total weight of the second cap sublayer. In some embodiments, the second cap sublayer comprises 75% to 80% by weight of the second fire retardant based on the total weight of the second cap sublayer.

In some embodiments, the second cap sublayer comprises 10% to 90% by weight of the filler based on the total weight of the second cap sublayer. In some embodiments, the second cap sublayer comprises 10% to 85% by weight of the filler based on the total weight of the second cap sublayer. In some embodiments, the second cap sublayer comprises 10% to 80% by weight of the filler based on the total weight of the second cap sublayer. In some embodiments, the second cap sublayer comprises 10% to 75% by weight of the filler based on the total weight of the second cap sublayer. In some embodiments, the second cap sublayer comprises 10% to 70% by weight of the filler based on the total weight of the second cap sublayer. In some embodiments, the second cap sublayer comprises 10% to 65% by weight of the filler based on the total weight of the second cap sublayer. In some embodiments, the second cap sublayer comprises 10% to 60% by weight of the filler based on the total weight of the second cap sublayer. In some embodiments, the second cap sublayer comprises 10% to 55% by weight of the filler based on the total weight of the second cap sublayer. In some embodiments, the second cap sublayer comprises 10% to 50% by weight of the filler based on the total weight of the second cap sublayer. In some embodiments, the second cap sublayer comprises 10% to 45% by weight of the filler based on the total weight of the second cap sublayer. In some embodiments, the second cap sublayer comprises 10% to 40% by weight of the filler based on the total weight of the second cap sublayer. In some embodiments, the second cap sublayer comprises 10% to 35% by weight of the filler based on the total weight of the second cap sublayer. In some embodiments, the second cap sublayer comprises 10% to 30% by weight of the filler based on the total weight of the second cap sublayer. In some embodiments, the second cap sublayer comprises 10% to 25% by weight of the filler based on the total weight of the second cap sublayer. In some embodiments, the second cap sublayer comprises 10% to 20% by weight of the filler based on the total weight of the second cap sublayer. In some embodiments, the second cap sublayer comprises 10% to 15% by weight of the filler based on the total weight of the second cap sublayer.

In some embodiments, the second cap sublayer comprises 15% to 90% by weight of the filler based on the total weight of the second cap sublayer. In some embodiments, the second cap sublayer comprises 20% to 90% by weight of the filler based on the total weight of the second cap sublayer. In some embodiments, the second cap sublayer comprises 25% to 90% by weight of the filler based on the total weight of the second cap sublayer. In some embodiments, the second cap sublayer comprises 30% to 90% by weight of the filler based on the total weight of the second cap sublayer. In some embodiments, the second cap sublayer comprises 35% to 90% by weight of the filler based on the total weight of the second cap sublayer. In some embodiments, the second cap sublayer comprises 40% to 90% by weight of the filler based on the total weight of the second cap sublayer. In some embodiments, the second cap sublayer comprises 45% to 90% by weight of the filler based on the total weight of the second cap sublayer. In some embodiments, the second cap sublayer comprises 50% to 90% by weight of the filler based on the total weight of the second cap sublayer. In some embodiments, the second cap sublayer comprises 55% to 90% by weight of the filler based on the total weight of the second cap sublayer. In some embodiments, the second cap sublayer comprises 60% to 90% by weight of the filler based on the total weight of the second cap sublayer. In some embodiments, the second cap sublayer comprises 65% to 90% by weight of the filler based on the total weight of the second cap sublayer. In some embodiments, the second cap sublayer comprises 70% to 90% by weight of the filler based on the total weight of the second cap sublayer. In some embodiments, the second cap sublayer comprises 75% to 90% by weight of the filler based on the total weight of the second cap sublayer. In some embodiments, the second cap sublayer comprises 80% to 90% by weight of the filler based on the total weight of the second cap sublayer. In some embodiments, the second cap sublayer comprises 85% to 90% by weight of the filler based on the total weight of the second cap sublayer.

In some embodiments, the second cap sublayer comprises at least one of a dispersing agent, an adhesion promoter, a colorant, a viscosity modifier, an ultraviolet (UV) absorber, a crosslinking agent, or any combination thereof.

In some embodiments, the dispersing agent comprises at least one of isopropyl alcohol, sodium dodecylbenzenesulfonate, sodium dodecylsulfonate, polyvinylpyrrolidone, sodium cholate, polystyrene, polyvinyl alcohol, or any combination thereof. In some embodiments, the dispersing agent is present in an amount of 0.1% to 10% by weight based on the total weight of the second cap sublayer, or any range or subrange therebetween.

In some embodiments, the adhesion promoter comprises at least one of tackifiers, styrene-butadiene-styrene copolymer (SBS) modifiers, atactic polypropylene (APP) modifiers, asphalt emulsions, ethylene vinyl acetate (EVA) copolymers, fatty acids, polyamines, tall oils, paraffin waxes, or any combination thereof. In some embodiments, the adhesion promoter is present in an amount of 0.01% to 5% by weight based on the total weight of the second cap sublayer, or any range or subrange therebetween.

In some embodiments, the colorant includes at least one of a mixed metal oxide pigment, a pearlescent pigment, a metal-coated flake, a metal oxide coated plate-like pigment, a mica, a metallic flake, an infrared-reflective pigment, a metallic powder, or any combination thereof. In some embodiments, the colorant is present in an amount of 0.5% to 50% by weight based on the total weight of the second cap sublayer, or any range or subrange therebetween.

In some embodiments, the viscosity modifier comprises at least one of hydroxyl ethyl cellulose (HEC), polyacrylamide (PAA), rheology modifiers, cellulosics, acrylics, associated thickeners, clays, organoclays, hydrogenated caster oils, polyamides, overbased sulphonates, or any combination thereof. In some embodiments, the viscosity modifier is present in an amount of 0.01% to 5% by weight based on the total weight of at least one of the second cap sublayer, or any range or subrange therebetween.

In some embodiments, the UV absorber comprises at least one of hindered amines, anti-oxidants, benzotriazoles, benzophenones, organic nickel compounds, cyanoacrylates, nanoparticles, zinc oxides, anatase, rutiles, or any combination thereof. In some embodiments, the UV absorber is present in an amount of 0.05% to 10% by weight based on the total weight of the second cap sublayer, or any range or subrange therebetween.

In some embodiments, the cross-linking agent comprises at least one of n-butyl polytitanate (BTP), phthalates, titanium chelates, titanium acetylacetonates, or any combination thereof. In some embodiments, the cross-linking agent is present in an amount of 0.01% to 5% by weight based on the total weight of the second cap sublayer, or any range or subrange therebetween.

In some embodiments, the second cap layer has a thickness of 10 mils to 100 mils. In some embodiments, the second cap layer has a thickness of 10 mils to 95 mils. In some embodiments, the second cap layer has a thickness of 10 mils to 90 mils. In some embodiments, the second cap layer has a thickness of 10 mils to 85 mils. In some embodiments, the second cap layer has a thickness of 10 mils to 80 mils. In some embodiments, the second cap layer has a thickness of 10 mils to 75 mils. In some embodiments, the second cap layer has a thickness of 10 mils to 70 mils. In some embodiments, the second cap layer has a thickness of 10 mils to 65 mils. In some embodiments, the second cap layer has a thickness of 10 mils to 60 mils. In some embodiments, the second cap layer has a thickness of 10 mils to 55 mils. In some embodiments, the second cap layer has a thickness of 10 mils to 50 mils. In some embodiments, the second cap layer has a thickness of 10 mils to 45 mils. In some embodiments, the second cap layer has a thickness of 10 mils to 40 mils. In some embodiments, the second cap layer has a thickness of 10 mils to 35 mils. In some embodiments, the second cap layer has a thickness of 10 mils to 30 mils. In some embodiments, the second cap layer has a thickness of 10 mils to 25 mils. In some embodiments, the second cap layer has a thickness of 10 mils to 20 mils. In some embodiments, the second cap layer has a thickness of 10 mils to 15 mils.

In some embodiments, the second cap layer has a thickness of 15 mils to 100 mils. In some embodiments, the second cap layer has a thickness of 20 mils to 100 mils. In some embodiments, the second cap layer has a thickness of 25 mils to 100 mils. In some embodiments, the second cap layer has a thickness of 30 mils to 100 mils. In some embodiments, the second cap layer has a thickness of 35 mils to 100 mils. In some embodiments, the second cap layer has a thickness of 40 mils to 100 mils. In some embodiments, the second cap layer has a thickness of 45 mils to 100 mils. In some embodiments, the second cap layer has a thickness of 50 mils to 100 mils. In some embodiments, the second cap layer has a thickness of 55 mils to 100 mils. In some embodiments, the second cap layer has a thickness of 60 mils to 100 mils. In some embodiments, the second cap layer has a thickness of 65 mils to 100 mils. In some embodiments, the second cap layer has a thickness of 70 mils to 100 mils. In some embodiments, the second cap layer has a thickness of 75 mils to 100 mils. In some embodiments, the second cap layer has a thickness of 80 mils to 100 mils. In some embodiments, the second cap layer has a thickness of 85 mils to 100 mils. In some embodiments, the second cap layer has a thickness of 90 mils to 100 mils. In some embodiments, the second cap layer has a thickness of 95 mils to 100 mils.

In some embodiments, a thickness of the second cap sublayer is greater than a thickness of the first cap sublayer.

In some embodiments, the cap layer has a thickness of 1 mil to 100 mils. In some embodiments, the cap layer has a thickness of 1 mil to 95 mils. In some embodiments, the cap layer has a thickness of 1 mil to 90 mils. In some embodiments, the cap layer has a thickness of 1 mil to 85 mils. In some embodiments, the cap layer has a thickness of 1 mil to 80 mils. In some embodiments, the cap layer has a thickness of 1 mil to 75 mils. In some embodiments, the cap layer has a thickness of 1 mil to 70 mils. In some embodiments, the cap layer has a thickness of 1 mil to 65 mils. In some embodiments, the cap layer has a thickness of 1 mil to 60 mils. In some embodiments, the cap layer has a thickness of 1 mil to 55 mils. In some embodiments, the cap layer has a thickness of 1 mil to 50 mils. In some embodiments, the cap layer has a thickness of 1 mil to 45 mils. In some embodiments, the cap layer has a thickness of 1 mil to 40 mils. In some embodiments, the cap layer has a thickness of 1 mil to 35 mils. In some embodiments, the cap layer has a thickness of 1 mil to 30 mils. In some embodiments, the cap layer has a thickness of 1 mil to 25 mils. In some embodiments, the cap layer has a thickness of 1 mil to 20 mils. In some embodiments, the cap layer has a thickness of 1 mil to 15 mils. In some embodiments, the cap layer has a thickness of 1 mil to 10 mils. In some embodiments, the cap layer has a thickness of 1 mil to 5 mils.

In some embodiments, the cap layer has a thickness of 5 mils to 100 mils. In some embodiments, the cap layer has a thickness of 10 mils to 100 mils. In some embodiments, the cap layer has a thickness of 15 mils to 100 mils. In some embodiments, the cap layer has a thickness of 20 mils to 100 mils. In some embodiments, the cap layer has a thickness of 25 mils to 100 mils. In some embodiments, the cap layer has a thickness of 30 mils to 100 mils. In some embodiments, the cap layer has a thickness of 35 mils to 100 mils. In some embodiments, the cap layer has a thickness of 40 mils to 100 mils. In some embodiments, the cap layer has a thickness of 45 mils to 100 mils. In some embodiments, the cap layer has a thickness of 50 mils to 100 mils. In some embodiments, the cap layer has a thickness of 55 mils to 100 mils. In some embodiments, the cap layer has a thickness of 60 mils to 100 mils. In some embodiments, the cap layer has a thickness of 65 mils to 100 mils. In some embodiments, the cap layer has a thickness of 70 mils to 100 mils. In some embodiments, the cap layer has a thickness of 75 mils to 100 mils. In some embodiments, the cap layer has a thickness of 80 mils to 100 mils. In some embodiments, the cap layer has a thickness of 85 mils to 100 mils. In some embodiments, the cap layer has a thickness of 90 mils to 100 mils. In some embodiments, the cap layer has a thickness of 95 mils to 100 mils.

In some embodiments, the membrane comprises the substrate.

In some embodiments, the substrate is located between the cap layer and the core layer. In some embodiments, the substrate is located between the second cap sublayer and the core layer. In some embodiments, the substrate directly contacts the cap layer. In some embodiments, the substrate directly contacts the second cap sublayer. In some embodiments, the substrate directly contacts the core layer. In some embodiments, the substrate is adhered to the second cap sublayer. In some embodiments, the substrate is adhered to the cap layer. In some embodiments, the substrate is adhered to the core layer. In some embodiments, the substrate is bonded to the second cap sublayer. In some embodiments, the substrate is bonded to the cap layer. In some embodiments, the substrate is bonded to the core layer. In some embodiments, the substrate and the cap layer are coextruded layers. In some embodiments, the substrate and core layer are coextruded layers. In some embodiments, the substrate and the cap layer are laminated layers. In some embodiments, the substrate and the core layer are laminated layers.

In some embodiments, an intervening layer is located between the cap layer and the substrate. In some embodiments, an intervening layer is located between the second cap sublayer and the substrate. In some embodiments, an intervening layer is located between the core layer and the substrate. In some embodiments, the intervening layer comprises an adhesive layer. In some embodiments, the substrate is configured to directly contact a roofing substrate. In some embodiments, when the membrane is installed, the substrate directly contacts a roofing substrate.

In some embodiments, the substrate is a reinforcement layer. In some embodiments, the substrate is a support layer. In some embodiments, the substrate comprises at least one of a mesh, a fabric, a fleece, a mat, a scrim, a coated scrim, a woven, a non-woven, or any combination thereof. In some embodiments, the substrate comprises at least one of a spunbond mat, a spunlaced mat, an airlaid mat, a meltblown mat, or any combination thereof. In some embodiments, the substrate comprises a fibrous material, wherein the fibrous material comprises at least one of a natural fiber, a synthetic fiber, or any combination thereof. In some embodiments, the substrate comprises at least one of a polyolefin (e.g., at least one of a polyethylene, a polypropylene, any copolymer thereof, any blend thereof, or any combination thereof), a polyester, a polyamide, a glass, a fiberglass, or any combination thereof. In some embodiments, the substrate comprises, for example, a fiberglass mat. In some embodiments, the substrate comprises at least one of polyethylene terephthalate (PET), a thermoplastic polyolefin, a polypropylene, a polyurethane, an acrylic, a polyvinyl chloride, or any combination thereof. In some embodiments, the substrate comprises a PET scrim.

In some embodiments, the substrate has a thickness of 1 mil to 200 mils. In some embodiments, the substrate has a thickness of 10 mils to 200 mils. In some embodiments, the substrate has a thickness of 20 mils to 200 mils. In some embodiments, the substrate has a thickness of 30 mils to 200 mils. In some embodiments, the substrate has a thickness of 40 mils to 200 mils. In some embodiments, the substrate has a thickness of 50 mils to 200 mils. In some embodiments, the substrate has a thickness of 60 mils to 200 mils. In some embodiments, the substrate has a thickness of 70 mils to 200 mils. In some embodiments, the substrate has a thickness of 80 mils to 200 mils. In some embodiments, the substrate has a thickness of 90 mils to 200 mils. In some embodiments, the substrate has a thickness of 100 mils to 200 mils. In some embodiments, the substrate has a thickness of 110 mils to 200 mils. In some embodiments, the substrate has a thickness of 120 mils to 200 mils. In some embodiments, the substrate has a thickness of 130 mils to 200 mils. In some embodiments, the substrate has a thickness of 140 mils to 200 mils. In some embodiments, the substrate has a thickness of 150 mils to 200 mils. In some embodiments, the substrate has a thickness of 160 mils to 200 mils. In some embodiments, the substrate has a thickness of 170 mils to 200 mils. In some embodiments, the substrate has a thickness of 180 mils to 200 mils. In some embodiments, the substrate has a thickness of 190 mils to 200 mils.

In some embodiments, the substrate has a thickness of 1 mil to 190 mils. In some embodiments, the substrate has a thickness of 1 mil to 180 mils. In some embodiments, the substrate has a thickness of 1 mil to 170 mils. In some embodiments, the substrate has a thickness of 1 mil to 160 mils. In some embodiments, the substrate has a thickness of 1 mil to 150 mils. In some embodiments, the substrate has a thickness of 1 mil to 140 mils. In some embodiments, the substrate has a thickness of 1 mil to 130 mils. In some embodiments, the substrate has a thickness of 1 mil to 120 mils. In some embodiments, the substrate has a thickness of 1 mil to 110 mils. In some embodiments, the substrate has a thickness of 1 mil to 100 mils. In some embodiments, the substrate has a thickness of 1 mil to 90 mils. In some embodiments, the substrate has a thickness of 1 mil to 80 mils. In some embodiments, the substrate has a thickness of 1 mil to 70 mils. In some embodiments, the substrate has a thickness of 1 mil to 60 mils. In some embodiments, the substrate has a thickness of 1 mil to 50 mils. In some embodiments, the substrate has a thickness of 1 mil to 40 mils. In some embodiments, the substrate has a thickness of 1 mil to 30 mils. In some embodiments, the substrate has a thickness of 1 mil to 20 mils.

In some embodiments, the substrate has a thickness of 1 mil to 10 mils. In some embodiments, the substrate has a thickness of 1 mil to 9 mils. In some embodiments, the substrate has a thickness of 1 mil to 8 mils. In some embodiments, the substrate has a thickness of 1 mil to 7 mils. In some embodiments, the substrate has a thickness of 1 mil to 6 mils. In some embodiments, the substrate has a thickness of 1 mil to 5 mils. In some embodiments, the substrate has a thickness of 1 mil to 4 mils. In some embodiments, the substrate has a thickness of 1 mil to 3 mils. In some embodiments, the substrate has a thickness of 1 mil to 2 mils. In some embodiments, the substrate has a thickness of 2 mil to 10 mils. In some embodiments, the substrate has a thickness of 3 mil to 10 mils. In some embodiments, the substrate has a thickness of 4 mil to 10 mils. In some embodiments, the substrate has a thickness of 5 mil to 10 mils. In some embodiments, the substrate has a thickness of 6 mil to 10 mils. In some embodiments, the substrate has a thickness of 7 mil to 10 mils. In some embodiments, the substrate has a thickness of 8 mil to 10 mils. In some embodiments, the substrate has a thickness of 9 mil to 10 mils.

In some embodiments, the membrane comprises the core layer.

In some embodiments, the core layer directly contacts the substrate. In some embodiments, the core layer is bonded to the cap layer, optionally through the interstices of the substrate. For example, in some embodiments, the core layer and the cap layer are fused together though the interstices of the substrate. In some embodiments, the core layer is configured to directly contact a roofing substrate. In some embodiments, when the membrane is installed, the core layer directly contacts a roofing substrate. In some embodiments, the core layer is adhered to the substrate. In some embodiments, the core layer is bonded to the substrate. In some embodiments, the core layer comprises at least two coextruded sublayers. In some embodiments, the core layer comprises at least two laminated sublayers. In some embodiments, the core layer is laminated with the substrate. In some embodiments, when the membrane is installed, an intervening layer is located between the core layer and the roofing substrate. In some embodiments, the core layer is configured to directly contact the intervening layer. In some embodiments, when the membrane is installed, the core layer directly contacts the intervening layer.

In some embodiments, the core layer comprises one layer. In some embodiments, the core layer is an innermost layer of the membrane. For example, in some embodiments, the core layer, when the membrane is installed, is not exposed to an environment. In some embodiments, the core layer comprises one or more sublayers. For example, although not shown, it will be appreciated that, in some embodiments, the core layer may comprise a plurality of core sublayers. For example, in some embodiments, the core layer comprises a first core sublayer, a second core sublayer, a third core sublayer, a fourth core sublayer, a fifth core sublayer, a sixth core sublayer, a seventh core sublayer, an eighth core sublayer, a ninth core sublayer, a tenth core sublayer, up to 100 or more core sublayers. In some embodiments, each of the one or more core sublayers directly contact each other. In some embodiments, an intervening layer is located between at least two core sublayers. For example, in some embodiments, an adhesive layer is located between at least two core sublayers.

In some embodiments, the core layer comprises a polymer. In some embodiments, the polymer comprises a thermoplastic polymer, such as, for example and without limitation, a thermoplastic polyolefin. In some embodiments, the polymer comprises at least one of a polyolefin, a polypropylene, a polyethylene, a polypropylene impact copolymer, an olefin block copolymer, a polypropylene elastomer, a polyethylene elastomer, or any combination thereof. In some embodiments, the polymer comprises at least one of ethylene-1-octene copolymer, propylene-ethylene copolymer, ethylene-1-butene copolymer, propylene-ethylene-1-butene copolymer, ethylene-1-hexene copolymer, ethylene-1-octene copolymer, ethylene-1-hexene-1-octene copolymer, propylene-ethylene-1-hexene copolymer, propylene-ethylene-1-octene copolymer, ethylene-1-butene-1-octene copolymer, or any combination thereof. In some embodiments, the second olefin block copolymer comprises or is selected from the group consisting of at least one of propylene-ethylene copolymer, ethylene-1-octene copolymer, propylene-ethylene 1-butene copolymer, propylene-ethylene-1-hexene copolymer, propylene-ethylene-1-octene copolymer, ethylene-1-butene-1-octene copolymer, or any combination thereof.

Some non-limiting examples of the polymer (e.g., such as, one or more of thermoplastic polymers, polyolefins, thermoplastic polyolefins (TPO), vinyl polymers, polyvinyl esters, thermoplastic elastomers, recycled polymers, etc.) may include, without limitation, one or more of the following: polysiloxanes, silyl-terminated polymers (e.g., silyl-terminated polyethers and silyl-terminated polyurethanes, etc.), polyethylenes (PE) (e.g., including, without limitation, one or more of raw low density polyethylene, recycled low density polyethylene (LDPE), linear low density polyethylene (LLDPE), and high density polyethylene (HDPE)), polypropylene (PP) (e.g., including, without limitation, one or more of isotactic polypropylene (IPP), atactic polypropylene/isotactic propylene (APP/IPP)), polystyrene, polyurethane (PU/TPU), polyurea, terpolymers (e.g., including, without limitation, a functionalized polymer with a reactive oxygen group), amorphous polyalpha olefins (APAO), amorphous polyolefins (APO), (e.g., including, without limitation, one or more of propylene homopolymers, copolymers of propylene and ethylene, copolymers of ethylene alpha-olefin, such as ethylene and 1-octene, ethylene and 1-hexene, and ethylene and 1-butene), polyolefin elastomers (POE), styrene/styrenic block copolymers (e.g., including, without limitation, one or more of styrenic block copolymers with a hydrogenated midblock of styrene-ethylene/butylene-styrene (SEBS), styrene-ethylene/propylene-styrene (SEPS), styrene-isoprene-styrene block copolymers (SIS), and styrene-butadiene-styrene block copolymers (SBS)), ethylene vinyl acetate (EVA), polyisobutylene, polybutadiene, oxidized polyethylene, epoxy thermoplastics, raw polyvinyl butyral (PVB), polyvinyl chloride (PVC), recycled polyvinyl butyral (rPVB), polyvinyl acetate (PVAC), poly (vinyl butyrate), poly (vinyl propionate), poly (vinyl formate), and copolymers of PVAC (e.g., including, without limitation, copolymers of PVAC and EVA). Some non-limiting examples of the at least one polymer (e.g., including, without limitation, thermoplastic polymers, polyolefins, vinyl polymers, polyvinyl esters, and thermoplastic elastomers) may include, without limitation, one or more of the following: Vistamaxx® 6102 and Vistamaxx® 8880, which are polypropylenes (e.g., isotactic polypropylene (IPP)) and which are available from ExxonMobil, Irving, Tex.; Elvaloy®, which is a terpolymer and which is available from Dow/DuPont, Wilmington, Del.; Fusabond®, which is a chemically modified ethylene acrylate copolymer, a modified polyethylene, or any combination thereof and which is available from Dow/DuPont, Wilmington, Del.; RT2304, which is an amorphous polyalpha olefin (APAO) and which is available from Rextac APAO Polymers LLC, Odessa, Tex.; Eastoflex® P1023, which is an amorphous polyolefin (APO) comprising a propylene homopolymer and which is available from Eastman Chemical Company, Kingsport, Tenn.; Eastoflex® E1060, which is an amorphous polyolefin (APO) comprising a copolymer of propylene and ethylene and which is available from Eastman Chemical Company, Kingsport, Tenn.; Eastoflex® M1025, which is an amorphous polyolefin (APO) that comprises a blend of propylene homopolymer and copolymers of propylene and ethylene and which is available from Eastman Chemical Company, Kingsport, Tenn.; Engage® 7487, which is a polyolefin elastomer (POE) and which is available from Dow Inc., Midland, Mich.; SEBS 1657, which is a linear triblock copolymer based on styrene and ethylene/butylene, namely, styrene-ethylene/butylene-styrene (SEBS) and which is available Kraton™ Corporation, Houston, Tex.; D0243, D0246, D1101, D1102, D1116, D1118, D1152, D1155, D1157, D1184, D1189, D1191, and D1194, which are styrene butadiene styrene block copolymers comprising blocks of styrene and butadiene and which is available Kraton™ Corporation, Houston, Tex.; PI131350, which is a polyisobutylene and which is available from TPC Group, Houston, Tex.; ethylene bis stearamide (EBS), which is available from ACME-Hardesty Company, Blue Bell, Pa.; IPP, which is available from Bay Polymer Corp., Fremont, Calif.; and recycled low density polyethylene, which is available from Avangard Innovative, Houston, Tex. In some embodiments, the polymer comprises a polypropylene copolymer.

In some embodiments, at least one of the polymers of the core layer is the same as at least one of the polymers of the cap layer. In some embodiments, at least one of the polymers of the core layer is different from at least one of the polymers of the cap layer.

In some embodiments, the core layer comprises a fire retardant. In some embodiments, the fire retardant comprises a substance that, when present, increases a fire resistance of the membrane relative to a membrane which does not comprise a fire retardant. In some embodiments, the fire retardant comprises a halogenated fire retardant. In some embodiments, the fire retardant comprises a non-halogenated fire retardant. In some embodiments, the fire retardant comprises a halogenated fire retardant and a non-halogenated fire retardant. In some embodiments, the fire retardant comprises at least one of magnesium hydroxide, magnesium dihydroxide, alumina trihydrate, zinc borate, ammonium polyphosphate, melamine polyphosphate, antimony oxide, hexabromocyclododecane, graphite, expandable graphite, N,N′-ethylene-bis(tetrabromophthalimide), or any combination thereof.

In some embodiments, the core layer comprises a filler material. In some embodiments, the filler material comprises at least one of at least one of nepheline syenite, calcium carbonate, barium sulfate, iron oxide, diatomaceous earth, melamine, quartz, colloidal silica, crystalline silica, precipitated silica, amorphous silica, fumed silica, titanium dioxide, zinc oxide, zirconium oxide, zirconium silicate, zinc borate, chromic oxide, crystalline silica fine powder, amorphous silica fine powder, fumed silica powder, silicone rubber powder, glass powder, silica hydrogen, silica aero gel, calcium silicate, aluminum silicate, aluminum oxide, ferrite, carbon black, mica, clay, bentonite, ground quartz, kaolin, calcined kaolin, wollastonite, hydroxyapatite, hydrated alumina, magnesium hydroxide, vermiculite, talcum, slaked lime, calcium sulfate, talc, limestone, perlite, silica, colemanite, fly ash, recycled rubber tires, recycled shingles, recycled thermoplastic resins, basalt, or any combination thereof.

In some embodiments, the core layer comprises 10% to 90% by weight of the polymer based on a total weight of the core layer. In some embodiments, the core layer comprises 10% to 85% by weight of the polymer based on the total weight of the core layer. In some embodiments, the core layer comprises 10% to 80% by weight of the polymer based on the total weight of the core layer. In some embodiments, the core layer comprises 10% to 75% by weight of the polymer based on the total weight of the core layer. In some embodiments, the core layer comprises 10% to 70% by weight of the polymer based on the total weight of the core layer. In some embodiments, the core layer comprises 10% to 65% by weight of the polymer based on the total weight of the core layer. In some embodiments, the core layer comprises 10% to 60% by weight of the polymer based on the total weight of the core layer. In some embodiments, the core layer comprises 10% to 55% by weight of the polymer based on the total weight of the core layer. In some embodiments, the core layer comprises 10% to 50% by weight of the polymer based on the total weight of the core layer. In some embodiments, the core layer comprises 10% to 45% by weight of the polymer based on the total weight of the core layer. In some embodiments, the core layer comprises 10% to 40% by weight of the polymer based on the total weight of the core layer. In some embodiments, the core layer comprises 10% to 35% by weight of the polymer based on the total weight of the core layer. In some embodiments, the core layer comprises 10% to 30% by weight of the polymer based on the total weight of the core layer. In some embodiments, the core layer comprises 10% to 25% by weight of the polymer based on the total weight of the core layer. In some embodiments, the core layer comprises 10% to 20% by weight of the polymer based on the total weight of the core layer. In some embodiments, the core layer comprises 10% to 15% by weight of the polymer based on the total weight of the core layer.

In some embodiments, the core layer comprises 15% to 90% by weight of the polymer based on the total weight of the core layer. In some embodiments, the core layer comprises 20% to 90% by weight of the polymer based on the total weight of the core layer. In some embodiments, the core layer comprises 25% to 90% by weight of the polymer based on the total weight of the core layer. In some embodiments, the core layer comprises 30% to 90% by weight of the polymer based on the total weight of the core layer. In some embodiments, the core layer comprises 35% to 90% by weight of the polymer based on the total weight of the core layer. In some embodiments, the core layer comprises 40% to 90% by weight of the polymer based on the total weight of the core layer. In some embodiments, the core layer comprises 45% to 90% by weight of the polymer based on the total weight of the core layer. In some embodiments, the core layer comprises 50% to 90% by weight of the polymer based on the total weight of the core layer. In some embodiments, the core layer comprises 55% to 90% by weight of the polymer based on the total weight of the core layer. In some embodiments, the core layer comprises 60% to 90% by weight of the polymer based on the total weight of the core layer. In some embodiments, the core layer comprises 65% to 90% by weight of the polymer based on the total weight of the core layer. In some embodiments, the core layer comprises 70% to 90% by weight of the polymer based on the total weight of the core layer. In some embodiments, the core layer comprises 75% to 90% by weight of the polymer based on the total weight of the core layer. In some embodiments, the core layer comprises 80% to 90% by weight of the polymer based on the total weight of the core layer. In some embodiments, the core layer comprises 85% to 90% by weight of the polymer based on the total weight of the core layer.

In some embodiments, the core layer comprises 10% to 80% by weight of the fire retardant based on the total weight of the core layer. In some embodiments, the core layer comprises 10% to 75% by weight of the fire retardant based on the total weight of the core layer. In some embodiments, the core layer comprises 10% to 70% by weight of the fire retardant based on the total weight of the core layer. In some embodiments, the core layer comprises 10% to 65% by weight of the fire retardant based on the total weight of the core layer. In some embodiments, the core layer comprises 10% to 60% by weight of the fire retardant based on the total weight of the core layer. In some embodiments, the core layer comprises 10% to 55% by weight of the fire retardant based on the total weight of the core layer. In some embodiments, the core layer comprises 10% to 50% by weight of the fire retardant based on the total weight of the core layer. In some embodiments, the core layer comprises 10% to 45% by weight of the fire retardant based on the total weight of the core layer. In some embodiments, the core layer comprises 10% to 40% by weight of the fire retardant based on the total weight of the core layer. In some embodiments, the core layer comprises 10% to 35% by weight of the fire retardant based on the total weight of the core layer. In some embodiments, the core layer comprises 10% to 30% by weight of the fire retardant based on the total weight of the core layer. In some embodiments, the core layer comprises 10% to 25% by weight of the fire retardant based on the total weight of the core layer. In some embodiments, the core layer comprises 10% to 20% by weight of the fire retardant based on the total weight of the core layer. In some embodiments, the core layer comprises 10% to 15% by weight of the fire retardant based on the total weight of the core layer.

In some embodiments, the core layer comprises 15% to 80% by weight of the fire retardant based on the total weight of the core layer. In some embodiments, the core layer comprises 20% to 80% by weight of the fire retardant based on the total weight of the core layer. In some embodiments, the core layer comprises 25% to 80% by weight of the fire retardant based on the total weight of the core layer. In some embodiments, the core layer comprises 30% to 80% by weight of the fire retardant based on the total weight of the core layer. In some embodiments, the core layer comprises 35% to 80% by weight of the fire retardant based on the total weight of the core layer. In some embodiments, the core layer comprises 40% to 80% by weight of the fire retardant based on the total weight of the core layer. In some embodiments, the core layer comprises 45% to 80% by weight of the fire retardant based on the total weight of the core layer. In some embodiments, the core layer comprises 50% to 80% by weight of the fire retardant based on the total weight of the core layer. In some embodiments, the core layer comprises 55% to 80% by weight of the fire retardant based on the total weight of the core layer. In some embodiments, the core layer comprises 60% to 80% by weight of the fire retardant based on the total weight of the core layer. In some embodiments, the core layer comprises 65% to 80% by weight of the fire retardant based on the total weight of the core layer. In some embodiments, the core layer comprises 70% to 80% by weight of the fire retardant based on the total weight of the core layer. In some embodiments, the core layer comprises 75% to 80% by weight of the fire retardant based on the total weight of the core layer.

In some embodiments, the core layer comprises 10% to 90% by weight of the filler based on the total weight of the core layer. In some embodiments, the core layer comprises 10% to 85% by weight of the filler based on the total weight of the core layer. In some embodiments, the core layer comprises 10% to 80% by weight of the filler based on the total weight of the core layer. In some embodiments, the core layer comprises 10% to 75% by weight of the filler based on the total weight of the core layer. In some embodiments, the core layer comprises 10% to 70% by weight of the filler based on the total weight of the core layer. In some embodiments, the core layer comprises 10% to 65% by weight of the filler based on the total weight of the core layer. In some embodiments, the core layer comprises 10% to 60% by weight of the filler based on the total weight of the core layer. In some embodiments, the core layer comprises 10% to 55% by weight of the filler based on the total weight of the core layer. In some embodiments, the core layer comprises 10% to 50% by weight of the filler based on the total weight of the core layer. In some embodiments, the core layer comprises 10% to 45% by weight of the filler based on the total weight of the core layer. In some embodiments, the core layer comprises 10% to 40% by weight of the filler based on the total weight of the core layer. In some embodiments, the core layer comprises 10% to 35% by weight of the filler based on the total weight of the core layer. In some embodiments, the core layer comprises 10% to 30% by weight of the filler based on the total weight of the core layer. In some embodiments, the core layer comprises 10% to 25% by weight of the filler based on the total weight of the core layer. In some embodiments, the core layer comprises 10% to 20% by weight of the filler based on the total weight of the core layer. In some embodiments, the core layer comprises 10% to 15% by weight of the filler based on the total weight of the core layer.

In some embodiments, the core layer comprises 15% to 90% by weight of the filler based on the total weight of the core layer. In some embodiments, the core layer comprises 20% to 90% by weight of the filler based on the total weight of the core layer. In some embodiments, the core layer comprises 25% to 90% by weight of the filler based on the total weight of the core layer. In some embodiments, the core layer comprises 30% to 90% by weight of the filler based on the total weight of the core layer. In some embodiments, the core layer comprises 35% to 90% by weight of the filler based on the total weight of the core layer. In some embodiments, the core layer comprises 40% to 90% by weight of the filler based on the total weight of the core layer. In some embodiments, the core layer comprises 45% to 90% by weight of the filler based on the total weight of the core layer. In some embodiments, the core layer comprises 50% to 90% by weight of the filler based on the total weight of the core layer. In some embodiments, the core layer comprises 55% to 90% by weight of the filler based on the total weight of the core layer. In some embodiments, the core layer comprises 60% to 90% by weight of the filler based on the total weight of the core layer. In some embodiments, the core layer comprises 65% to 90% by weight of the filler based on the total weight of the core layer. In some embodiments, the core layer comprises 70% to 90% by weight of the filler based on the total weight of the core layer. In some embodiments, the core layer comprises 75% to 90% by weight of the filler based on the total weight of the core layer. In some embodiments, the core layer comprises 80% to 90% by weight of the filler based on the total weight of the core layer. In some embodiments, the core layer comprises 85% to 90% by weight of the filler based on the total weight of the core layer.

In some embodiments, the core layer comprises at least one of a dispersing agent, an adhesion promoter, a colorant, a viscosity modifier, an ultraviolet (UV) absorber, a crosslinking agent, or any combination thereof.

In some embodiments, the dispersing agent comprises at least one of isopropyl alcohol, sodium dodecylbenzenesulfonate, sodium dodecylsulfonate, polyvinylpyrrolidone, sodium cholate, polystyrene, polyvinyl alcohol, or any combination thereof. In some embodiments, the dispersing agent is present in an amount of 0.1% to 10% by weight based on the total weight of the core layer, or any range or subrange therebetween.

In some embodiments, the adhesion promoter comprises at least one of tackifiers, styrene-butadiene-styrene copolymer (SBS) modifiers, atactic polypropylene (APP) modifiers, asphalt emulsions, ethylene vinyl acetate (EVA) copolymers, fatty acids, polyamines, tall oils, paraffin waxes, or any combination thereof. In some embodiments, the adhesion promoter is present in an amount of 0.01% to 5% by weight based on the total weight of the core layer, or any range or subrange therebetween.

In some embodiments, the colorant includes at least one of a mixed metal oxide pigment, a pearlescent pigment, a metal-coated flake, a metal oxide coated plate-like pigment, a mica, a metallic flake, an infrared-reflective pigment, a metallic powder, or any combination thereof. In some embodiments, the colorant is present in an amount of 0.5% to 50% by weight based on the total weight of the core layer, or any range or subrange therebetween.

In some embodiments, the viscosity modifier comprises at least one of hydroxyl ethyl cellulose (HEC), polyacrylamide (PAA), rheology modifiers, cellulosics, acrylics, associated thickeners, clays, organoclays, hydrogenated caster oils, polyamides, overbased sulphonates, or any combination thereof. In some embodiments, the viscosity modifier is present in an amount of 0.01% to 5% by weight based on the total weight of at least one of the core layer, or any range or subrange therebetween.

In some embodiments, the UV absorber comprises at least one of hindered amines, anti-oxidants, benzotriazoles, benzophenones, organic nickel compounds, cyanoacrylates, nanoparticles, zinc oxides, anatase, rutiles, or any combination thereof. In some embodiments, the UV absorber is present in an amount of 0.05% to 10% by weight based on the total weight of the core layer, or any range or subrange therebetween.

In some embodiments, the cross-linking agent comprises at least one of n-butyl polytitanate (BTP), phthalates, titanium chelates, titanium acetylacetonates, or any combination thereof. In some embodiments, the cross-linking agent is present in an amount of 0.01% to 5% by weight based on the total weight of the core layer, or any range or subrange therebetween.

In some embodiments, at least one sublayer of the core layer has a thickness of 1 mil to 100 mils. In some embodiments, at least one sublayer of the core layer has a thickness of 1 mil to 95 mils. In some embodiments, at least one sublayer of the core layer has a thickness of 1 mil to 90 mils. In some embodiments, at least one sublayer of the core layer has a thickness of 1 mil to 85 mils. In some embodiments, at least one sublayer of the core layer has a thickness of 1 mil to 80 mils. In some embodiments, at least one sublayer of the core layer has a thickness of 1 mil to 75 mils. In some embodiments, at least one sublayer of the core layer has a thickness of 1 mil to 70 mils. In some embodiments, at least one sublayer of the core layer has a thickness of 1 mil to 65 mils. In some embodiments, at least one sublayer of the core layer has a thickness of 1 mil to 60 mils. In some embodiments, at least one sublayer of the core layer has a thickness of 1 mil to 55 mils. In some embodiments, at least one sublayer of the core layer has a thickness of 1 mil to 50 mils. In some embodiments, at least one sublayer of the core layer has a thickness of 1 mil to 45 mils. In some embodiments, at least one sublayer of the core layer has a thickness of 1 mil to 40 mils. In some embodiments, at least one sublayer of the core layer has a thickness of 1 mil to 35 mils. In some embodiments, at least one sublayer of the core layer has a thickness of 1 mil to 30 mils. In some embodiments, at least one sublayer of the core layer has a thickness of 1 mil to 25 mils. In some embodiments, at least one sublayer of the core layer has a thickness of 1 mil to 20 mils. In some embodiments, at least one sublayer of the core layer has a thickness of 1 mil to 15 mils. In some embodiments, at least one sublayer of the core layer has a thickness of 1 mil to 10 mils. In some embodiments, at least one sublayer of the core layer has a thickness of 1 mil to 5 mils.

In some embodiments, at least one sublayer of the core layer has a thickness of 5 mils to 100 mils. In some embodiments, at least one sublayer of the core layer has a thickness of 10 mils to 100 mils. In some embodiments, at least one sublayer of the core layer has a thickness of 15 mils to 100 mils. In some embodiments, at least one sublayer of the core layer has a thickness of 20 mils to 100 mils. In some embodiments, at least one sublayer of the core layer has a thickness of 25 mils to 100 mils. In some embodiments, at least one sublayer of the core layer has a thickness of 30 mils to 100 mils. In some embodiments, at least one sublayer of the core layer has a thickness of 35 mils to 100 mils. In some embodiments, at least one sublayer of the core layer has a thickness of 40 mils to 100 mils. In some embodiments, at least one sublayer of the core layer has a thickness of 45 mils to 100 mils. In some embodiments, at least one sublayer of the core layer has a thickness of 50 mils to 100 mils. In some embodiments, at least one sublayer of the core layer has a thickness of 55 mils to 100 mils. In some embodiments, at least one sublayer of the core layer has a thickness of 60 mils to 100 mils. In some embodiments, at least one sublayer of the core layer has a thickness of 65 mils to 100 mils. In some embodiments, at least one sublayer of the core layer has a thickness of 70 mils to 100 mils. In some embodiments, at least one sublayer of the core layer has a thickness of 75 mils to 100 mils. In some embodiments, at least one sublayer of the core layer has a thickness of 80 mils to 100 mils. In some embodiments, at least one sublayer of the core layer has a thickness of 85 mils to 100 mils. In some embodiments, at least one sublayer of the core layer has a thickness of 90 mils to 100 mils. In some embodiments, at least one sublayer of the core layer has a thickness of 95 mils to 100 mils.

In some embodiments, the core layer has a thickness of 5 mils to 100 mils. In some embodiments, the core layer has a thickness of 10 mils to 100 mils. In some embodiments, the core layer has a thickness of 15 mils to 100 mils. In some embodiments, the core layer has a thickness of 20 mils to 100 mils. In some embodiments, the core layer has a thickness of 25 mils to 100 mils. In some embodiments, the core layer has a thickness of 30 mils to 100 mils. In some embodiments, the core layer has a thickness of 35 mils to 100 mils. In some embodiments, the core layer has a thickness of 40 mils to 100 mils. In some embodiments, the core layer has a thickness of 45 mils to 100 mils. In some embodiments, the core layer has a thickness of 50 mils to 100 mils. In some embodiments, the core layer has a thickness of 55 mils to 100 mils. In some embodiments, the core layer has a thickness of 60 mils to 100 mils. In some embodiments, the core layer has a thickness of 65 mils to 100 mils. In some embodiments, the core layer has a thickness of 70 mils to 100 mils. In some embodiments, the core layer has a thickness of 75 mils to 100 mils. In some embodiments, the core layer has a thickness of 80 mils to 100 mils. In some embodiments, the core layer has a thickness of 85 mils to 100 mils. In some embodiments, the core layer has a thickness of 90 mils to 100 mils. In some embodiments, the core layer has a thickness of 95 mils to 100 mils.

In some embodiments, the membrane comprises an adhesive layer.

In some embodiments, the adhesive layer is located between the core layer and, when the membrane is installed, a roofing substrate. In some embodiments, when the membrane is installed, the adhesive layer is configured to contact a roofing substrate. In some embodiments, the adhesive layer is configured to adhere the membrane to a roofing substrate. In some embodiments, the adhesive layer directly contacts the core layer. In some embodiments, the adhesive layer, when the membrane is installed, directly contacts a roofing substrate. In some embodiments, the adhesive layer is located between one or more additional layers. For example, in some embodiments, the adhesive layer is located between the cap layer and the substrate. In some embodiments, the adhesive layer is located between the first cap sublayer and the second cap sublayer. In some embodiments, the adhesive layer is located between the second cap sublayer and the substrate. In some embodiments, the adhesive layer is located between the substrate and the core layer. In some embodiments, the adhesive layer is located between one or more sublayers of the core layer. In some embodiments, the adhesive layer directly contacts the cap layer. In some embodiments, the adhesive layer directly contacts the substrate. In some embodiments, the adhesive layer directly contacts the first cap sublayer. In some embodiments, the adhesive layer directly contacts the second cap sublayer. In some embodiments, the adhesive layer directly contacts the core layer. In some embodiments, the adhesive layer directly contacts one or more sublayers of the core layer.

In some embodiments, the roofing membrane comprises an adhesive layer.

In some embodiments, the adhesive layer has a thickness of 1 mil to 200 mils. In some embodiments, the adhesive layer has a thickness of 10 mil to 200 mils. In some embodiments, the adhesive layer has a thickness of 20 mil to 200 mils. In some embodiments, the adhesive layer has a thickness of 30 mil to 200 mils. In some embodiments, the adhesive layer has a thickness of 40 mil to 200 mils. In some embodiments, the adhesive layer has a thickness of 50 mil to 200 mils. In some embodiments, the adhesive layer has a thickness of 60 mil to 200 mils. In some embodiments, the adhesive layer has a thickness of 70 mil to 200 mils. In some embodiments, the adhesive layer has a thickness of 80 mil to 200 mils. In some embodiments, the adhesive layer has a thickness of 90 mil to 200 mils. In some embodiments, the adhesive layer has a thickness of 100 mil to 200 mils. In some embodiments, the adhesive layer has a thickness of 110 mil to 200 mils. In some embodiments, the adhesive layer has a thickness of 120 mil to 200 mils. In some embodiments, the adhesive layer has a thickness of 130 mil to 200 mils. In some embodiments, the adhesive layer has a thickness of 140 mil to 200 mils. In some embodiments, the adhesive layer has a thickness of 150 mil to 200 mils. In some embodiments, the adhesive layer has a thickness of 160 mil to 200 mils. In some embodiments, the adhesive layer has a thickness of 170 mil to 200 mils. In some embodiments, the adhesive layer has a thickness of 180 mil to 200 mils. In some embodiments, the adhesive layer has a thickness of 190 mil to 200 mils.

In some embodiments, the adhesive layer has a thickness of 1 mil to 190 mils. In some embodiments, the adhesive layer has a thickness of 1 mil to 180 mils. In some embodiments, the adhesive layer has a thickness of 1 mil to 170 mils. In some embodiments, the adhesive layer has a thickness of 1 mil to 160 mils. In some embodiments, the adhesive layer has a thickness of 1 mil to 150 mils. In some embodiments, the adhesive layer has a thickness of 1 mil to 140 mils. In some embodiments, the adhesive layer has a thickness of 1 mil to 130 mils. In some embodiments, the adhesive layer has a thickness of 1 mil to 120 mils. In some embodiments, the adhesive layer has a thickness of 1 mil to 110 mils. In some embodiments, the adhesive layer has a thickness of 1 mil to 100 mils. In some embodiments, the adhesive layer has a thickness of 1 mil to 90 mils. In some embodiments, the adhesive layer has a thickness of 1 mil to 80 mils. In some embodiments, the adhesive layer has a thickness of 1 mil to 70 mils. In some embodiments, the adhesive layer has a thickness of 1 mil to 60 mils. In some embodiments, the adhesive layer has a thickness of 1 mil to 50 mils. In some embodiments, the adhesive layer has a thickness of 1 mil to 40 mils. In some embodiments, the adhesive layer has a thickness of 1 mil to 30 mils. In some embodiments, the adhesive layer has a thickness of 1 mil to 20 mils. In some embodiments, the adhesive layer has a thickness of 1 mil to 10 mils.

In some embodiments, the adhesive layer has a thickness of 1 mil to 9 mils. In some embodiments, the adhesive layer has a thickness of 1 mil to 8 mils. In some embodiments, the adhesive layer has a thickness of 1 mil to 7 mils. In some embodiments, the adhesive layer has a thickness of 1 mil to 6 mils. In some embodiments, the adhesive layer has a thickness of 1 mil to 5 mils. In some embodiments, the adhesive layer has a thickness of 1 mil to 4 mils. In some embodiments, the adhesive layer has a thickness of 1 mil to 3 mils. In some embodiments, the adhesive layer has a thickness of 1 mil to 2 mils. In some embodiments, the adhesive layer has a thickness of 2 mil to 10 mils. In some embodiments, the adhesive layer has a thickness of 3 mil to 10 mils. In some embodiments, the adhesive layer has a thickness of 4 mil to 10 mils. In some embodiments, the adhesive layer has a thickness of 5 mil to 10 mils. In some embodiments, the adhesive layer has a thickness of 6 mil to 10 mils. In some embodiments, the adhesive layer has a thickness of 7 mil to 10 mils. In some embodiments, the adhesive layer has a thickness of 8 mil to 10 mils. In some embodiments, the adhesive layer has a thickness of 9 mil to 10 mils.

In some embodiments, the adhesive layer comprises at least one adhesive. In some embodiments, the at least one adhesive comprises at least one of a hot melt adhesive, a solvent-based adhesive, a pressure sensitive adhesive, a water-based adhesive, a UV cured or UV curable polymer, or any combination thereof. In some embodiments, the at least one adhesive comprises at least one of an asphaltic adhesive, a butyl adhesive, a silicone adhesive, an acrylic adhesive, a synthetic thermoplastic elastomer, a natural rubber, or any combination thereof. In some embodiments, the at least one adhesive comprises at least one of thermosetting polyolefin, thermoplastic polyolefin (TPO), polyvinyl butyrate, silicone, polycarbonate, butyl rubber, styrene-butadiene-styrene (SBS), styrene-isoprene-styrene (SIS), styrene butadiene (SB), styrene-ethylene-butadiene-styrene (SEBS), ethylene vinyl acetate (EVA), a resin, a hydrocarbon resin, a rosin resin, a natural wax, a petroleum wax, an oil, bitumen, a solvent, vinyl acetate, an acrylic polymers, an acrylic copolymer, (e.g., at least one of vinyl acetate acrylic, ethylene vinyl acetate, styrene acrylic, vinyl chloride acrylic, vinyl versatate, or any combination thereof), or any combination thereof. In some embodiments, the at least one adhesive comprises at one elastomer. In some embodiments, the at least one elastomer comprises at least one of a butyl rubber, a styrenic block copolymer, or any combination thereof.

In some embodiments, the at least one adhesive comprises at least one of an asphaltic adhesive, a butyl adhesive, a silicone adhesive, an epoxy adhesive, a polyurethane adhesive, an acrylic adhesive, or any combination thereof. In some embodiments, the at least one adhesive comprises at least one of thermosetting polyolefin, thermoplastic polyolefin (TPO), polyvinyl butyrate, silicone, polycarbonate, butyl rubber, styrene, styrene-butadiene-styrene (SBS), styrene-isoprene-styrene (SIS), styrene butadiene (SB), styrene-ethylene-butadiene-styrene (SEBS), ethylene vinyl acetate (EVA), a resin, a hydrocarbon resin, a rosin resin, a natural wax, a petroleum wax, an oil, bitumen, a solvent, vinyl acetate, an acrylic polymer, an acrylic copolymer, (e.g., at least one of vinyl acetate acrylic, ethylene vinyl acetate, an ethylene acrylic, styrene acrylic, vinyl chloride acrylic, vinyl versatate, or any combination thereof), a silyl modified polymer, a silane terminated polymer, natural rubber, a polyolefin polymer, a poly-alpha-olefin (APAO/APO) polymer, a polyamide polyvinyl acetate, a polyvinyl alcohol, a polyamide, a polyester, a polyester amide, or any combination thereof.

In some embodiments, the membrane comprises a release liner. In some embodiments, the release liner covers at least a portion of the adhesive layer. In some embodiments, the release liner covers an entire surface of the adhesive layer.

In some embodiments, the roofing membrane, when tested according to CRRC-1 Method #1, has a three-year aged solar reflectance that is greater than a control roofing membrane, wherein the control roofing membrane does not comprise the first cap sublayer. In some embodiments, the roofing membrane, when tested according to CRRC-1 Method #1, has a three-year aged solar reflectance that is 1% to 20% greater than the control roofing membrane. In some embodiments, the roofing membrane, when tested according to CRRC-1 Method #1, has a three-year aged solar reflectance that is 1% to 18% greater than the control roofing membrane. In some embodiments, the roofing membrane, when tested according to CRRC-1 Method #1, has a three-year aged solar reflectance that is 1% to 16% greater than the control roofing membrane. In some embodiments, the roofing membrane, when tested according to CRRC-1 Method #1, has a three-year aged solar reflectance that is 1% to 15% greater than the control roofing membrane. In some embodiments, the roofing membrane, when tested according to CRRC-1 Method #1, has a three-year aged solar reflectance that is 1% to 14% greater than the control roofing membrane. In some embodiments, the roofing membrane, when tested according to CRRC-1 Method #1, has a three-year aged solar reflectance that is 1% to 12% greater than the control roofing membrane. In some embodiments, the roofing membrane, when tested according to CRRC-1 Method #1, has a three-year aged solar reflectance that is 1% to 10% greater than the control roofing membrane. In some embodiments, the roofing membrane, when tested according to CRRC-1 Method #1, has a three-year aged solar reflectance that is 1% to 9% greater than the control roofing membrane. In some embodiments, the roofing membrane, when tested according to CRRC-1 Method #1, has a three-year aged solar reflectance that is 1% to 8% greater than the control roofing membrane. In some embodiments, the roofing membrane, when tested according to CRRC-1 Method #1, has a three-year aged solar reflectance that is 1% to 7% greater than the control roofing membrane. In some embodiments, the roofing membrane, when tested according to CRRC-1 Method #1, has a three-year aged solar reflectance that is 1% to 6% greater than the control roofing membrane. In some embodiments, the roofing membrane, when tested according to CRRC-1 Method #1, has a three-year aged solar reflectance that is 1% to 5% greater than the control roofing membrane. In some embodiments, the roofing membrane, when tested according to CRRC-1 Method #1, has a three-year aged solar reflectance that is 1% to 4% greater than the control roofing membrane. In some embodiments, the roofing membrane, when tested according to CRRC-1 Method #1, has a three-year aged solar reflectance that is 1% to 3% greater than the control roofing membrane. In some embodiments, the roofing membrane, when tested according to CRRC-1 Method #1, has a three-year aged solar reflectance that is 1% to 2% greater than the control roofing membrane.

In some embodiments, the roofing membrane, when tested according to CRRC-1 Method #1, has a three-year aged solar reflectance that is 2% to 20% greater than the control roofing membrane. In some embodiments, the roofing membrane, when tested according to CRRC-1 Method #1, has a three-year aged solar reflectance that is 4% to 20% greater than the control roofing membrane. In some embodiments, the roofing membrane, when tested according to CRRC-1 Method #1, has a three-year aged solar reflectance that is 5% to 20% greater than the control roofing membrane. In some embodiments, the roofing membrane, when tested according to CRRC-1 Method #1, has a three-year aged solar reflectance that is 6% to 20% greater than the control roofing membrane. In some embodiments, the roofing membrane, when tested according to CRRC-1 Method #1, has a three-year aged solar reflectance that is 8% to 20% greater than the control roofing membrane. In some embodiments, the roofing membrane, when tested according to CRRC-1 Method #1, has a three-year aged solar reflectance that is 10% to 20% greater than the control roofing membrane. In some embodiments, the roofing membrane, when tested according to CRRC-1 Method #1, has a three-year aged solar reflectance that is 12% to 20% greater than the control roofing membrane. In some embodiments, the roofing membrane, when tested according to CRRC-1 Method #1, has a three-year aged solar reflectance that is 14% to 20% greater than the control roofing membrane. In some embodiments, the roofing membrane, when tested according to CRRC-1 Method #1, has a three-year aged solar reflectance that is 15% to 20% greater than the control roofing membrane. In some embodiments, the roofing membrane, when tested according to CRRC-1 Method #1, has a three-year aged solar reflectance that is 16% to 20% greater than the control roofing membrane. In some embodiments, the roofing membrane, when tested according to CRRC-1 Method #1, has a three-year aged solar reflectance that is 18% to 20% greater than the control roofing membrane.

In some embodiments, a three-year aged solar reflectance of the roofing membrane, when tested according to CRRC-1 Method #1, is within 10% of an initial solar reflectance of the roofing membrane. In some embodiments, a three-year aged solar reflectance of the roofing membrane, when tested according to CRRC-1 Method #1, is within 9% of an initial solar reflectance of the roofing membrane. In some embodiments, a three-year aged solar reflectance of the roofing membrane, when tested according to CRRC-1 Method #1, is within 8% of an initial solar reflectance of the roofing membrane. In some embodiments, a three-year aged solar reflectance of the roofing membrane, when tested according to CRRC-1 Method #1, is within 7% of an initial solar reflectance of the roofing membrane. In some embodiments, a three-year aged solar reflectance of the roofing membrane, when tested according to CRRC-1 Method #1, is within 6% of an initial solar reflectance of the roofing membrane. In some embodiments, a three-year aged solar reflectance of the roofing membrane, when tested according to CRRC-1 Method #1, is within 5% of an initial solar reflectance of the roofing membrane. In some embodiments, a three-year aged solar reflectance of the roofing membrane, when tested according to CRRC-1 Method #1, is within 4% of an initial solar reflectance of the roofing membrane. In some embodiments, a three-year aged solar reflectance of the roofing membrane, when tested according to CRRC-1 Method #1, is within 3% of an initial solar reflectance of the roofing membrane. In some embodiments, a three-year aged solar reflectance of the roofing membrane, when tested according to CRRC-1 Method #1, is within 2% of an initial solar reflectance of the roofing membrane. In some embodiments, a three-year aged solar reflectance of the roofing membrane, when tested according to CRRC-1 Method #1, is within 1% of an initial solar reflectance of the roofing membrane.

In some embodiments, the roofing membrane, when tested according to ASTM D6878 and when inspected at 7× magnification according to the 3″ Mandrel Bend Test, does not exhibit cracks when subjected to Xenon Arc exposures of 25,000 KJ/m².

In some embodiments, the roofing membrane, when tested according to ASTM D6878 at 275° F. and inspected at 7× magnification according to the 3″ Mandrel Bend Test, does not exhibit cracks for a duration of greater than 16 weeks. In some embodiments, the roofing membrane, when tested according to ASTM D6878 at 275° F. and inspected at 7× magnification according to the 3″ Mandrel Bend Test, does not exhibit cracks for a duration of 17 weeks. In some embodiments, the roofing membrane, when tested according to ASTM D6878 at 275° F. and inspected at 7× magnification according to the 3″ Mandrel Bend Test, does not exhibit cracks for a duration of 18 weeks. In some embodiments, the roofing membrane, when tested according to ASTM D6878 at 275° F. and inspected at 7× magnification according to the 3″ Mandrel Bend Test, does not exhibit cracks for a duration of 19 weeks. In some embodiments, the roofing membrane, when tested according to ASTM D6878 at 275° F. and inspected at 7× magnification according to the 3″ Mandrel Bend Test, does not exhibit cracks for a duration of 20 weeks. In some embodiments, the roofing membrane, when tested according to ASTM D6878 at 275° F. and inspected at 7× magnification according to the 3″ Mandrel Bend Test, does not exhibit cracks for a duration of 25 weeks. In some embodiments, the roofing membrane, when tested according to ASTM D6878 at 275° F. and inspected at 7× magnification according to the 3″ Mandrel Bend Test, does not exhibit cracks for a duration of 30 weeks. In some embodiments, the roofing membrane, when tested according to ASTM D6878 at 275° F. and inspected at 7× magnification according to the 3″ Mandrel Bend Test, does not exhibit cracks for a duration of 35 weeks. In some embodiments, the roofing membrane, when tested according to ASTM D6878 at 275° F. and inspected at 7× magnification according to the 3″ Mandrel Bend Test, does not exhibit cracks for a duration of 40 weeks. In some embodiments, the roofing membrane, when tested according to ASTM D6878 at 275° F. and inspected at 7× magnification according to the 3″ Mandrel Bend Test, does not exhibit cracks for a duration of 45 weeks or more.

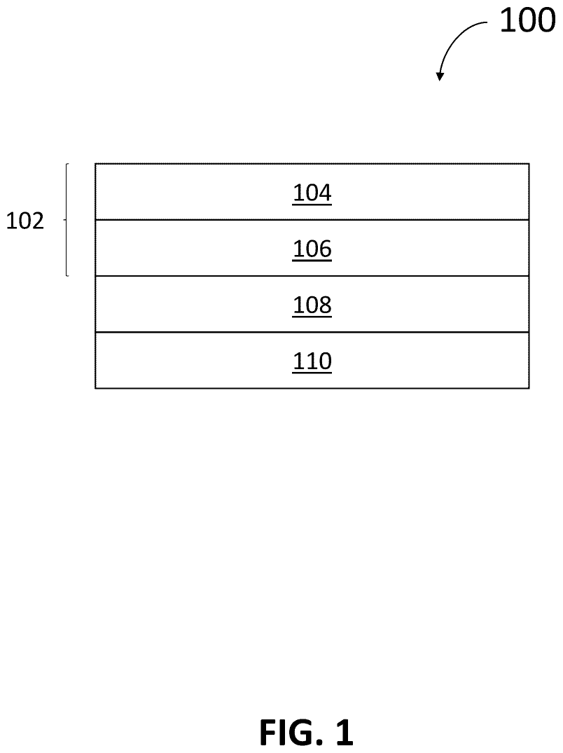

FIG. 1 is a schematic diagram of a cross-section of a roofing membrane 100, according to some embodiments. As shown in FIG. 1, in some embodiments, roofing membrane 100 comprises a cap layer 102. In some embodiments, the cap layer 102 comprises a first cap sublayer 104. In some embodiments, the cap layer 102 comprises a second cap sublayer 106. In some embodiments, the roofing membrane 100 comprises a substrate 108. In some embodiments, the roofing membrane 100 comprises a core layer 110. In some embodiments, the second cap sublayer 106 is located between the first cap sublayer 104 and the substrate 108. In some embodiments, the second cap sublayer 106 directly contacts the first cap sublayer 104. In some embodiments, the second cap sublayer 106 directly contacts the substrate 108. In some embodiments, the substrate 108 is located between the second cap sublayer 106 and the core layer 110. In some embodiments, the substrate 108 directly contacts the second cap sublayer 106. In some embodiments, the substrate 108 directly contacts the core layer 110. In some embodiments, an intervening layer is located between the second cap sublayer 106 and the substrate 108. In some embodiments, an intervening layer is located between the substrate 108 and the core layer 110. It will be appreciated that any of the cap layers, substrates, core layers, and/or intervening layers disclosed herein may be used, without departing from the scope of this disclosure.

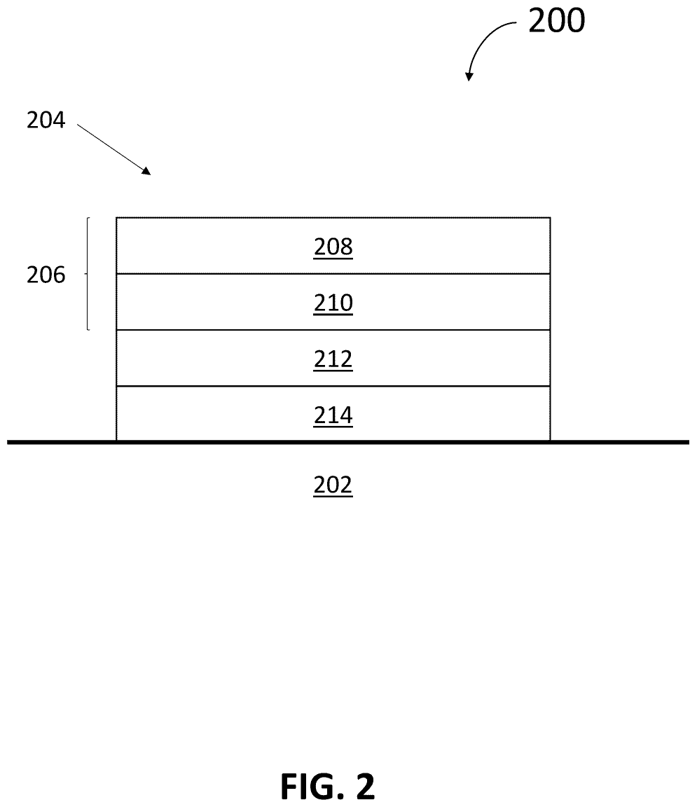

FIG. 2 is a schematic diagram of a cross-section of a roofing system 200, according to some embodiments. In some embodiments, the roofing system 200 comprises a roofing substrate 202. In some embodiments, the roofing system 200 comprises a roofing membrane 204. In some embodiments, the roofing membrane 204 comprises a cap layer 206. In some embodiments, the cap layer 206 comprises a first cap sublayer 208. In some embodiments, the cap layer 206 comprises a second cap sublayer 210. In some embodiments, the roofing membrane 204 comprises a substrate 212. In some embodiments, the roofing membrane 204 comprises a core layer 214. In some embodiments, the second cap sublayer 210 is located between the first cap sublayer 208 and the substrate 212. In some embodiments, the second cap sublayer 210 directly contacts the first cap sublayer 208. In some embodiments, the second cap sublayer 210 directly contacts the substrate 212. In some embodiments, the substrate 212 is located between the second cap sublayer 210 and the core layer 214. In some embodiments, the substrate 212 directly contacts the second cap sublayer 210. In some embodiments, the substrate 212 directly contacts the core layer 214. In some embodiments, the core layer 214 is located between the substrate 212 and the roofing substrate 202. In some embodiments, the core layer 214 directly contacts the substrate 212. In some embodiments, the core layer 214 directly contacts the roofing substrate 202. In some embodiments, an intervening layer is located between the second cap sublayer 210 and the substrate 212. In some embodiments, an intervening layer is located between the substrate 212 and the core layer 214. In some embodiments, an intervening layer is located between the core layer 214 and the roofing substrate 202. It will be appreciated that any of the membranes, cap layers, substrates, core layers, and/or intervening layers disclosed herein may be used, without departing from the scope of this disclosure.

In some embodiments, the roofing substrate 202 comprises at least one of a plywood substrate, a glass substrate, a cellulosic substrate, a roof shingle, a mat, a fabric, a glass mat, a fiberglass mat, an underlayment, a roofing membrane, a roof deck, a metal substrate, a protruding member, a photovoltaic (PV) panel, a modified bitumen (MODBIT) substrate, a roll good, a polyisocyanurate (ISO) foam board, a cover board, a pipe, a base sheet, a chimney, a wax paper, a cement, a concrete, or any combination thereof.

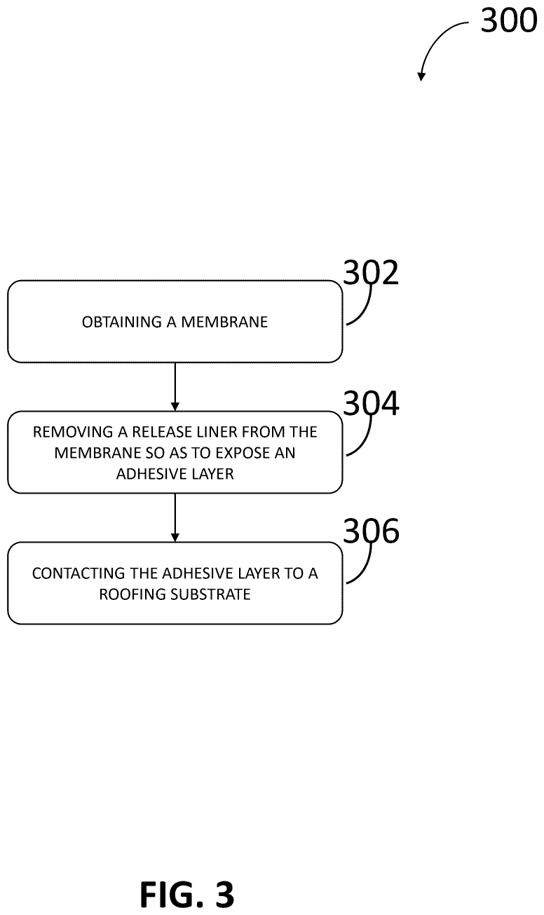

FIG. 3 is a flowchart of a method 300 for installing a membrane, according to some embodiments. As shown in FIG. 3, in some embodiments, the method of installation 300 comprises one or more of the following steps: obtaining 302 a roofing membrane; removing 304 a release liner from the roofing membrane, so as to expose an adhesive layer; and contacting 306 the adhesive layer to a roofing substrate, so as to adhere the roofing membrane to the roofing substrate.

In some embodiments, the method of installation 300 comprises obtaining 302 a roofing membrane. It will be appreciated that any of the membranes disclosed herein may be used, without departing from the scope of this disclosure. For example, in some embodiments, the roofing membrane comprises a cap layer. In some embodiments, the cap layer comprises a first cap sublayer. In some embodiments, the first cap sublayer comprises a first thermoplastic polymer. In some embodiments, the first cap sublayer comprises no greater than 10 parts of a first fire retardant per 100 parts of the first thermoplastic polymer. In some embodiments, the cap layer comprises a second cap sublayer. In some embodiments, the second cap sublayer comprises a second thermoplastic polymer. In some embodiments, the second cap sublayer comprises a second fire retardant. In some embodiments, an amount of the second fire retardant in the second cap sublayer is greater than an amount of the first fire retardant in the first cap sublayer. In some embodiments, the roofing membrane comprises a substrate. In some embodiments, the roofing membrane comprises a core layer. In some embodiments, the roofing membrane comprises an adhesive layer. In some embodiments, the roofing membrane comprises a release liner. In some embodiments, the second cap sublayer is located between the first cap sublayer and the substrate. In some embodiments, the substrate is located between the second cap sublayer and the core layer. In some embodiments, the core layer is located between the substrate and the adhesive layer. In some embodiments, the adhesive layer is located between the core layer and the release liner. In some embodiments, the release liner covers the adhesive layer.

In some embodiments, the method of installation 300 comprises removing 304 a release liner from the roofing membrane, so as to expose an adhesive layer. In some embodiments, the removing 304 comprises peeling the release liner from the roofing membrane. In some embodiments, the removing 304 comprises pulling the release liner from the roofing membrane. In some embodiments, the removing 304 comprises detaching the release liner from the roofing membrane. In some embodiments, the removing 304 comprises delaminating the release liner from the roofing membrane. In some embodiments, the removing 304 comprises uncovering the adhesive layer of the roofing membrane. In some embodiments, the removing 304 is sufficient to expose at least a portion of the adhesive layer. In some embodiments, the removing 304 is sufficient to expose the adhesive layer in its entirety. In some embodiments, the removing 304 is sufficient to expose a portion of the adhesive layer.

In some embodiments, the method of installation 300 comprises contacting 306 the adhesive layer to a roofing substrate, so as to adhere the roofing membrane to the roofing substrate. In some embodiments, the contacting 306 comprises adhering the roofing membrane to the roofing substrate. In some embodiments, the contacting 306 comprising directly contacting the adhesive layer of the roofing membrane to the roofing substrate. In some embodiments, the contacting 306 comprises positioning the roofing membrane over a surface to which the roofing membrane is to be adhered and subsequently adhering the roofing membrane to the surface of the roofing substrate. In some embodiments, the contacting 306 comprises applying pressure to the roofing membrane sufficient to adhere the roofing membrane to the roofing substrate. In some embodiments, the contacting 306 comprises moisture curing the adhesive layer sufficient to adhere the roofing membrane to the roofing substrate. In some embodiments, the contacting 306 comprises light curing the adhesive layer sufficient to adhere the roofing membrane to the roofing substrate. In some embodiments, the roofing membrane is secured to the roofing substrate by a mechanical fastener (e.g., nails, screws, clips, etc.), optionally with or without the adhering.

### Example 1

Two roofing membranes were constructed, and a solar reflectance of the roofing membranes was measured and compared to a control roofing membrane.

Each of the roofing membranes had a cap layer, a core layer, and a substrate located between the cap layer and the core layer. The cap layer of each roofing membrane had a first cap sublayer and a second cap sublayer, with the second cap sublayer located between the first cap sublayer and the substrate. The first cap sublayer had 0 to 5 parts of a fire retardant per 100 parts of a thermoplastic polyolefin (TPO). The second cap sublayer had at least 50 parts of the fire retardant per 100 parts of the thermoplastic polyolefin. These roofing membranes are referred to herein as Roofing Membrane 1 and Roofing Membrane 2.

The control roofing membrane was similar to Roofing Membrane 1 and Roofing Membrane 2 in composition and dimension, except the control roofing membrane did not have the first cap sublayer. That is, the control roofing membrane had a single layer cap layer, a core layer, and a substrate located between the single layer cap layer and the core layer. The single layer cap layer had at least 50 parts of the fire retardant per 100 parts of the thermoplastic polyolefin. The control roofing membrane is referred to herein as Control Roofing Membrane.

### Example 2

An initial solar reflectance and a three-year aged solar reflectance of Roofing Membrane 1 and the Control Roofing Membrane, both of which are described above in Example 1, were measured. The initial solar reflectance of the Roofing Membrane 1 and the Control Roofing Membrane was measured according to ASTM E903. The three-year aged solar reflectance of the Roofing Membrane 1 and the Control Roofing Membrane was measured according to CRRC-1 Method #1. The measured solar reflectance values are summarized in Table 2 below.

TABLE 2

| | Control Roofing | Roofing |
|---|---|---|
| | Membrane | Membrane 1 |
| Initial Solar | 0.76 | 0.79 |
| Reflectance (%) | | |
| Three-Year Aged Solar | 0.68 | 0.73 |
| Reflectance (%) | | |
| Decrease in Solar | 10.5 | 7.6 |
| Reflectance (%) | | |

As can be seen from Table 2, Roofing Membrane 1, when tested according to CRRC-1 Method #1, had a three-year aged solar reflectance that was greater than Control Roofing Membrane. In addition, the three-year aged solar reflectance of Roofing Membrane 1, when tested according to CRRC-1 Method #1, was within 10% of the initial solar reflectance of Roofing Membrane 1, whereas Control Roofing Membrane had a three-year aged solar reflectance, when tested according to CRRC-1 Method #1, that was not within 10% of the initial solar reflectance of Control Roofing Membrane.

### Example 3

Roofing Membrane 2 and Control Roofing Membrane were tested according to ASTM D6878 and were inspected at 7× magnification according to the 3″ Mandrel Bend Test. Each of the Roofing Membrane 2 and the Control Roofing Membrane were inspected for cracks when subjected to Xenon Arc exposures of 25,000 KJ/m². The results are summarized in Table 3 below.

TABLE 3

| | W-O-M (KJ/nm) |
|---|---|
| | (7x Crack Per |
| | ASTM D6878) |
| Control Roofing Membrane | >20,160 |
| Roofing Membrane 2 | >88,900 |

As can be seen from Table 3, the Roofing Membrane 3, when tested according to ASTM D6878 and when inspected at 7× magnification according to the 3″ Mandrel Bend Test, did not exhibit cracks when subjected to Xenon Arc exposures of 25,000 kJ/m². In contrast, the Control Roofing Membrane, when tested according to ASTM D6878 and when inspected at 7× magnification according to the 3″ Mandrel Bend Test, did exhibit cracks when subjected to Xenon Arc exposures of 25,000 KJ/m².

### Example 4

Roofing Membrane 2 and Control Roofing Membrane were tested according to ASTM D6878 at 275° F. and inspected at 7× magnification according to the 3″ Mandrel Bend Test. Each of the Roofing Membrane 2 and the Control Roofing Membrane were inspected for cracks were inspected at 20 weeks.

TABLE 4

| | 275° F. Aging |
|---|---|
| | (Days to 7x Crack) |
| Control Roofing Membrane | >16 weeks |
| Roofing Membrane 2 | >40 weeks |

As can be seen from Table 4, Roofing Membrane 2, when tested according to ASTM D6878 at 275° F. and inspected at 7× magnification according to the 3″ Mandrel Bend Test, did not exhibit cracks for a duration 20 weeks. In contrast, Control Roofing Membrane, when tested according to ASTM D6878 at 275° F. and inspected at 7× magnification according to the 3″ Mandrel Bend Test, did exhibit cracks for a duration 20 weeks.

What is claimed is:

1. A roofing membrane comprising:
a cap layer,
wherein the cap layer comprises:
a first cap sublayer,
wherein the first cap sublayer comprises:
a first thermoplastic polymer; and
a second cap sublayer,
wherein the second cap sublayer comprises:
a second thermoplastic polymer; and
20 parts to 90 parts of a second fire retardant per 100 parts of the second thermoplastic polymer;
a substrate; and
a core layer;
wherein the second cap sublayer is located between the first cap sublayer and the substrate;
wherein the substrate is located between the second cap sublayer and the core layer.

2. The roofing membrane of claim 1, wherein the first cap sublayer further comprises 1 part to 10 parts of a first fire retardant per 100 parts of the first thermoplastic polymer.

3. The roofing membrane of claim 1, wherein the first cap sublayer does not comprise a fire retardant.

4. The roofing membrane of claim 1, wherein the first cap sublayer directly contacts the second cap sublayer.

5. The roofing membrane of claim 1, wherein the second cap sublayer directly contacts the substrate.

6. The roofing membrane of claim 1, wherein the substrate directly contacts the core layer.

7. The roofing membrane of claim 1, wherein a thickness of the second cap sublayer is greater than a thickness of the first cap sublayer.

8. The roofing membrane of claim 1, wherein:
the first cap layer has a thickness of 1 mil to 10 mils; and
the second cap layer has a thickness of 10 mils to 100 mils.

9. The roofing membrane of claim 1, wherein the first thermoplastic polymer is the same as the second thermoplastic polymer.

10. The roofing membrane of claim 1, wherein the first thermoplastic polymer comprises a polypropylene copolymer.

11. The roofing membrane of claim 1, wherein the second fire retardant is present in the second cap sublayer in an amount sufficient for the roofing membrane, when installed on a roofing substrate and tested for fire resistance, to pass the Class A UL790 fire resistance test.

12. The roofing membrane of claim 11, wherein the roofing membrane, when tested according to ASTM D6878 and when inspected at 7× magnification according to the 3″ Mandrel Bend Test, does not exhibit cracks when subjected to Xenon Arc exposures of 25,000 KJ/m².

13. The roofing membrane of claim 1, wherein the roofing membrane, when tested according to CRRC-1 Method #1, has a three-year aged solar reflectance that is greater than a control roofing membrane, wherein the control roofing membrane does not comprise the first cap sublayer.

14. The roofing membrane of claim 1, wherein the roofing membrane, when tested according to ASTM D6878 at 275° F. and inspected at 7× magnification according to the 3″ Mandrel Bend Test, does not exhibit cracks for a duration 20 weeks.

15. A roofing system comprising:
a roofing substrate; and
a roofing membrane,
wherein the roofing membrane comprises:
a cap layer,
wherein the cap layer comprises:
a first cap sublayer,
wherein the first cap sublayer comprises:
a first thermoplastic polymer; and
1 part to 10 parts of a first fire retardant per 100 parts of the first thermoplastic polymer; and
a second cap sublayer,
wherein the second cap sublayer comprises:
a second thermoplastic polymer; and
20 parts to 90 parts of a second fire retardant per 100 parts of the second thermoplastic polymer;
a substrate; and
a core layer;
wherein the second cap sublayer is located between the first cap sublayer and the substrate;
wherein the substrate is located between the second cap sublayer and the core layer;
wherein the core layer is located between the substrate and the roofing substrate.

16. The roofing system of claim 14, wherein the roofing substrate comprises at least one of a plywood substrate, a glass substrate, a cellulosic substrate, a roof shingle, a mat, a fabric, a glass mat, a fiberglass mat, an underlayment, a roofing membrane, a roof deck, a metal substrate, a protruding member, a photovoltaic (PV) panel, a modified bitumen (MODBIT) substrate, a roll good, a polyisocyanurate (ISO) foam board, a cover board, a pipe, a base sheet, a chimney, a wax paper, or any combination thereof.

17. The roofing system of claim 14, wherein the first cap sublayer directly contacts the second cap sublayer.

18. The roofing system of claim 14, wherein the second cap sublayer directly contacts the substrate.

19. The roofing system of claim 14, wherein the substrate directly contacts the core layer.

20. A method of installation comprising:
obtaining a roofing membrane,
wherein the roofing membrane comprises:
a cap layer,
wherein the cap layer comprises:
a first cap sublayer,
wherein the first cap sublayer comprises:
a first thermoplastic polymer; and
1 part to 10 parts of a first fire retardant per 100 parts of the first thermoplastic polymer; and
a second cap sublayer,
wherein the second cap sublayer comprises:
a second thermoplastic polymer; and
20 parts to 90 parts of a second fire retardant per 100 parts of the second thermoplastic polymer;
a substrate;
a core layer;
an adhesive layer; and
a release liner;
wherein the second cap sublayer is located between the first cap sublayer and the substrate;
wherein the substrate is located between the second cap sublayer and the core layer;
wherein the core layer is located between the substrate and the adhesive layer;
wherein the adhesive layer is located between the core layer and the release liner;
wherein the release liner covers the adhesive layer;
removing the release liner from the adhesive layer, so as to expose the adhesive layer; and
contacting the adhesive layer to a roofing substrate, so as to adhere the roofing membrane to the roofing substrate.
